(19) United States
(12) Patent Application Publication
(10) Pub. No.: US 2026/0086832 A1
(43) Pub. Date: Mar. 26, 2026

(54) INTAKE PORTAL INTERFACE FOR AN ISSUE TRACKING PLATFORM

(71) Applicant: Atlassian Pty Ltd., Sydney (AU)

(72) Inventors: Ziqiu Zhang, Woodbridge, NJ (US); Joseph Andrew DeGregorio, Seattle, WA (US); Homer Chen, Calgary (CA); Pratyush Pandey, Bengaluru (IN)

(21) Appl. No.: 18/895,365

(22) Filed: Sep. 24, 2024

(51) Int. Cl. G06F 9/451; G06F 3/0486; H04L 51/046

(52) U.S. Cl. CPC G06F 9/453; G06F 3/0486; H04L 51/046

(57) ABSTRACT

Embodiments described herein relate to systems and methods for modifying an intake portal graphical user interface. The intake portal graphical user interface receives user input including a natural language user input or query which is processed using an intent analysis model. Output from the intent analysis model, including a set of confidence scores or intent signals, is used to modify the intake portal graphical user interface in order to direct the user to a synchronous or an asynchronous process flow for resolving the user query.

### TECHNICAL FIELD

Embodiments described herein relate to multi-tenant services of collaborative work environments and, in particular, to systems and methods for operating an intake portal interface for an issue tracking platform.

### BACKGROUND

An organization can employ software tools to assist with technical problems and interruptions in technical service. Typically, an issue tracking system or similar software platform may be used to track and manage technical problems logged by system users. However, traditional issue tracking systems may require significant resources and may not provide a timely resolution for some user-submitted requests. The systems and techniques described herein can be used to provide an intake portal interface for processing user input by using fewer computing resources and to efficiently handle a wider range of technical issues.

### SUMMARY

Embodiments described herein are directed to computer-implemented methods for providing an intake portal interface also referred to as an issue intake portal or intake portal graphical user interface. Some example embodiments are directed to a computer-implemented method for operating a graphical user interface of an issue intake portal. The method may include causing display of an intake portal graphical user interface of the issue intake portal on a client device. The intake portal graphical user interface may include a text input region configured to receive user input, a first graphical object selectable to cause redirection of the graphical user interface to an issue creation interface of an issue tracking platform, and a second graphical object selectable to cause redirection of the graphical user interface to a chat interface of a chat platform. In response to receiving at least a partial natural language input provided to the text input region, an analysis of the natural language input may be performed using an intent analysis model to obtain a set of confidence scores. The set of confidence scores may include: a first confidence score corresponding to a first intent for an asynchronous interface; and a second confidence score corresponding to a second intent for a synchronous interface. In response to the first confidence score exceeding the second confidence score by a first threshold value, the system may suppress display of the second graphical object, and in response to a user selection of the first graphical object, cause display of the issue creation graphical user interface of the issue tracking platform. In response to the second confidence score exceeding the first confidence score by a second threshold value the system may: suppress display of the first graphical object, and in response to a user selection of the second graphical object, cause display of the chat interface of the chat platform. In some cases, in response to the first confidence score and the second confidence score being above a third threshold value and within a fourth threshold value of each other, the system may maintain display of the first graphical object and the second graphical object.

In some examples, a prompt is generated in response to the first confidence score and the second confidence score being below a third threshold value. The prompt may include at least a portion of the natural language input, content extracted from one or more issues of the issue tracking platform; and predetermined prompt text. The prompt may be provided to a generative output engine to receive a generative response. The system may then cause display of a suggested input text string corresponding to the generative response in the text input region. In response to a second user input modifying the suggested input text string, the system may perform a second analysis of the modified suggested input text string using the intent analysis model to obtain a second set of confidence scores. The second set of confidence scores may include a third and fourth confidence score. In response to the third confidence score exceeding the fourth confidence score by the first threshold value, the system may suppress display of the second graphical object. In response to the fourth confidence score exceeding the third confidence score by the second threshold value, the system may suppress display of the first graphical object.

In some implementations, the set of confidence scores includes a third confidence score. In response to the third confidence score exceeding a third threshold value, the system may cause a search of the issue tracking platform using text extracted from the natural language user input to obtain a set of candidate electronic documents. The system may then cause display of a set of graphical objects, each graphical object selectable to cause the graphical user interface to be redirected to a respective one of the set of candidate electronic documents.

In some examples, in response to the first confidence score exceeding the second confidence score by the first threshold value, the system may suppress display of the second graphical object; and cause display of a link that is selectable to cause display of the chat interface.

In one example embodiment, subsequent to receiving the natural language input to the text input region, the system may receive a modified natural language input and perform an analysis of the modified natural language input using the intent analysis model to obtain a second set of confidence scores. The second set of confidence scores may include a third confidence score corresponding to the first intent for an asynchronous interface, and a fourth confidence score corresponding to the second intent for a synchronous interface. In response to the third confidence score exceeding the fourth confidence score by the first threshold value, the system may suppress display of the second graphical object. In response to the fourth confidence score exceeding the third confidence score by the second threshold value, the system may suppress display of the first graphical object.

Some example embodiments are directed to a computer implemented method including causing display of a graphical user interface of the issue intake portal on a client device, the graphical user interface including an editor region, a first selectable graphical object associated with an issue tracking platform, a second selectable graphical object associated with a communication platform. In response to receiving a first portion of a natural language input provided to a text input region, the system may provide the first portion of the natural language input to an intent analysis model trained using a training set of previously resolved issues processed by the issue tracking system and receive a set of confidence scores from the intent analysis model. In response to the set of confidence scores satisfying a synchronous criteria, the system may replace the first graphical object with a first selectable text string. In response to the set of confidence scores satisfying an asynchronous criteria, the system may replace the second graphical object with a second selectable text string or suppress display of the second graphical object and the second selectable text string. In response to a user selection of the first graphical object or the first selectable text string, the system may cause display of an issue creation graphical user interface of the issue tracking platform. In response to a user selection of the second graphical object or the second selectable text string, the system may cause display of an interface of the communication platform.

In some implementations, in response to receiving the first portion of the natural language input provided to the text input region, the system may obtain a user profile associated with an authenticated user of the client device, obtain role-specific data associated with the user role from the user profile, and provide the role-specific data along with the first portion of the natural language input to the intent analysis model.

In some cases, the intent analysis model is trained using the training set of previously resolved issues, which may be associated with a particular tenant and used to produce a tenant-specific model. In response to an authenticated user of the client device being associated with an account of the particular tenant, the system may select the tenant-specific model for use as the intent analysis model. In response to the authenticated user of the client device being associated with an account of a second tenant different than the particular tenant, the system may select a second model for use as the intent analysis model.

In some implementations, in response to the set of confidence scores satisfying a user-directed criteria, the system may cause a search of a knowledge base of content items using one or more tokens extracted from the natural language input to obtain a set of content item results. The set of content item results may be ranked based on a prior usage criteria. The system may cause display of a set of selectable objects in the graphical user interface, each selectable object of the set of selectable objects selectable to cause display of a respective one of a subset of top-ranking content items selected in accordance with the ranking. In some cases, ranking the set of content item results based on the prior usage criteria includes identifying articles associated with one or more previously resolved issues managed by the issue tracking platform.

In one example embodiment, subsequent to receiving the first portion of the natural language input, the system may receive a second portion of the natural language input. The system may then perform an analysis of the first and second portions of the natural language input using the intent analysis model to obtain a second set of confidence scores. In response to the set of second confidence scores satisfying a synchronous criteria, the system may replace the first graphical object with a first selectable text string.

In some example embodiments, subsequent to receiving the first portion of the natural language input, the system may receive a second portion of the natural language input. The system, may then perform an analysis of the first and second portions of the natural language input using the intent analysis model to obtain a second set of confidence scores. In response to the set of second confidence scores satisfying a synchronous criteria, the system may suppress display of the first graphical object. In response to the set of confidence scores satisfying an ambiguity criteria, the system may generate a prompt comprising: at least a portion of the first portion of the natural language input; content extracted from one or more issues of the issue tracking platform; and predetermined prompt text. The prompt may be provided to a generative output engine to receive a generative response. The system may cause display of a suggested input text string corresponding to the generative response in the text input region. In response to a second user input adopting or modifying the suggested input text string, the system may perform a second analysis of the modified or adopted suggested input text string using the intent analysis model to obtain a second set of confidence scores.

Some example embodiments are directed to a computer-implemented method for operating a graphical user interface of an issue intake portal. The system may cause display of an intake portal graphical user interface of the issue intake portal on a client device. The intake portal graphical user interface may include a first selectable graphical object associated with an issue tracking platform and a second selectable graphical object associated with a chat platform. In response to receiving a first portion of a natural language input provided to a text input region, the system may provide the first portion of the natural language input to an intent analysis model and obtaining a first set of confidence scores. The first set of confidence scores may include a first confidence score corresponding to a first intent, and a second confidence score corresponding to a second intent. In response to a first comparison between the first confidence score and the second confidence score satisfying an asynchronous criteria, the system may cease display of the second graphical object. In response to the first comparison between the first confidence score and the second confidence score satisfying a synchronous criteria, the system may cease display of the first graphical object. In response to receiving a second portion of the natural language input provided to the text input region, the system may provide the first and second portions of the natural language input to the intent analysis model and obtaining a second set of confidence scores including an updated first confidence score and an updated second confidence score. In response to a second comparison between the updated first confidence score and the updated second confidence score satisfying the asynchronous criteria, the system may cause display of the first graphical object. In response to the second comparison between the updated first confidence score and the updated second confidence score satisfying the synchronous criteria, the system may cause display of the second graphical object.

In some examples, the first portion of the natural language input includes a first portion of a sentence. In response to receiving the second portion of the natural language input including at least a second portion of the sentence, the system may perform an analysis of the first and second portions of the natural language input using the intent analysis model to obtain the second set of confidence scores.

In some cases, in response to receiving the first portion of the natural language input, the system may cause a search of a store of content items using a set of keywords extracted from the first portion of the natural language user input to obtain a set of content items. The system may then cause display of a set of selectable objects in the graphical user interface, each selectable object of the set of selectable objects selectable to cause display of a respective one content item of the set of content items.

In some implementations, in response to receiving the first portion of the natural language input, the system may cause a search of a store of content items using a set of keywords extracted from the first portion of the natural language user input to obtain a set of content items. The system may then cause display of a set of selectable objects in the graphical user interface, each selectable object of the set of selectable objects selectable to cause display of a respective one content item of the set of content items.

In some implementations, in response to the first comparison between the first confidence score and the second confidence score satisfying the synchronous criteria, the system may cease display of the first graphical object and replacing the first graphical object with a first text link. The first text link may be selectable to cause display of an interface of the issue tracking platform.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system for processing user requests using an issue intake portal.

FIG. 2 depicts an example process flow diagram for processing a user request submitted to an issue intake portal.

FIGS. 3A-3D depict example intake portal graphical user interfaces.

FIG. 4 depicts an example chat or messaging interface of a chat platform.

FIGS. 5A-5B depict example user interfaces of an issue tracking platform.

FIG. 6 depicts an example schematic of an issue tracking platform.

FIGS. 7A-7B depict an example portal for an issue tracking platform.

FIG. 7C depicts an example issue-creation form.

FIG. 8 depicts an example graphical user interface of an issue view in an issue tracking platform.

FIG. 9 depicts an example networked system for providing generative services.

FIG. 10A depicts a simplified diagram of a system, such as described herein that can include and/or may receive input from a generative output engine.

FIG. 10B depicts a functional system diagram of a system that can be used to implement a multiplatform prompt management service.

FIG. 11A depicts a simplified system diagram and data processing pipeline.

FIG. 11B depicts a system providing multiplatform prompt management as a service.

FIG. 12 depicts a sample electrical block diagram of an electronic device.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein are related to systems and methods for operating an issue intake portal and processing user requests submitted using an intake portal graphical user interface. In general, an issue intake portal, as described herein, is used to process user requests and can be used to redirect a graphical user interface of a client device to a platform or platform interface that is predicted to provide efficient and effective processing of the user request. The issue intake portal may be adapted to handle a wide variety of different types of user requests and, by analyzing the user input using an intent analysis model, can provide a customized or modified graphical user interface that provides a curated set of graphical objects that are automatically selected using the output of the intent analysis model. User input with respect to the curated set of graphical objects is used to advance the user request through the system using reduced computing resources, as compared to some traditional systems.

As described herein, a user request may be processed using a process flow or interface that is predicted to be most efficient based on the output of the intent analysis model, which is trained using previously processed issues, tickets, and other system objects. Generally, a user request may be processed in accordance with a process that can be characterized as an asynchronous process flow, in which electronic communication with the user is conducted in an asynchronous manner or may be characterized as a synchronous process flow, in which electronic communication with the user may be conducted synchronously or near-real time. By way of example, an asynchronous process flow may include the creation of an issue or ticket, which is processed by the issue tracking platform in accordance with an issue or ticket workflow. An asynchronous process flow may be most efficient when the user requests requires deep expertise or input from multiple agents or system users. However, an asynchronous process flow may be less efficient or effective for user requests that are more routine or requests that require frequent and timely communications from the user. In these cases, a synchronous process flow may be more efficient or effective. An example synchronous process flow may include the use of a real-time chat interface or other communication interface that is able to prompt the user with additional questions or assistance and gather feedback and other input from the user in near-real time. As also described herein, a user-executed process flow, also referred to as self-help, may be the most efficient or effective in situations in which there is adequate documentation or other resources that can be presented in response to the user query. The system may also implement hybrid or composite processes that include aspects of the asynchronous, synchronous, and/or user-executed process flows, which may allow the user and the agent to leverage different interfaces or aspects of the system at different times in the process flow or problem resolution.

As described herein, an intent analysis model may be used to determine a set of confidence scores based on an analysis of the user input including a natural language string or block of text provided to the intake portal graphical user interface. Each confidence score may correspond to a strength of prediction or intent signal with regard to a respective process flow (e.g., synchronous, asynchronous, self-executed) and an analysis of the confidence scores may be used to adapt the intake portal graphical user interface to best correspond to the nature of the user query. In particular, the relative strength of prediction can be used to adapt the user interface to bias the selections or controls to favor a particular process channel or interface, which may help to guide the user to an efficient resolution. As described herein, controls associated with strong intent signal may be emphasized while controls associated with weaker intent signals may be de-emphasized or suppressed from display. In some implementations, a weak or ambiguous intent signal may also be used to generate a suggested query or set of suggested queries that may be generated using a large-language model or similar generative system. User selection of a respective control or graphical object may cause the graphical user interface to be redirected to a platform or interface, which may facilitate an efficient resolution.

In some implementations, the graphical user interface may be adapted, in combination with the set of confidence scores, using one or more user- or client-specific attributes. For example, the role of an authenticated user, prior use history of an authenticated user, or client account associated with an authenticated user may be used to modify the graphical user interface of the intake portal to bias or emphasize a particular process flow or preferred interface. In some cases, the user- or client-specific attributes may be used to bias one or more confidence scores to bias the analysis toward a particular process flow. In other cases, a client-specific analysis of the confidence scores may be used or a client-specific model may be deployed that is trained to accommodate client-specific preferences or processes. The client-specific, attributes, analysis, or models may be used to emphasize a particular process flow or interface that is preferred for the respective client. For example, the client-specific, attributes, analysis, or models may favor a synchronous process flow if issue resolution criteria like time-to-resolution or incident response time are favored by the client. The attributes, analysis, or models may be used to emphasize an asynchronous process flow if a customer satisfaction score or incident recurrence rate criteria are favored by the client. Other factors may also be used to influence emphasis on a particular process flow including the time of day, available resources, service level of subscription, or other factors.

As described herein, the intake portal interface may be adapted based on a natural text user input provided to a text field or editor of the intake portal interface. In some implementations, the interface may be adapted dynamically in response to partial input, which may provide instant feedback to the user regarding which process flows may be preferred based on the current phrasing. The feedback may be used to prompt the user to provide more detail or rephrase the query if it appears that the user intent being determined does not match the actual intent of the user. As described previously, a large-language model or other model may be used to suggest modifications to the query or prompt sample user queries that are predicted to improve the resolvability or determination of user intent.

As described herein, the intent analysis model is used to determine a prediction or estimation of user intent. The model may include a transformer-type machine learning model that is trained using previously resolved user queries, issues, and electronic communications regarding the same. The intent analysis model may be trained using data that has been processed to remove personally identifiable information (PII) or other information that could be classified as company confidential information including names, project codes, financial data, and other potentially sensitive data. The intent analysis model may also be trained using company-specific terminology for products or software services that are being supported by the system. As described herein, the intent analysis model may be selected from a pool of candidate analysis models, each model adapted for a particular use case and may be trained using model-specific training sets. In some cases, the selection of the model is performed in response to identifying a particular tenant, company, or industry associated with an authenticated user operating the intake portal graphical user interface.

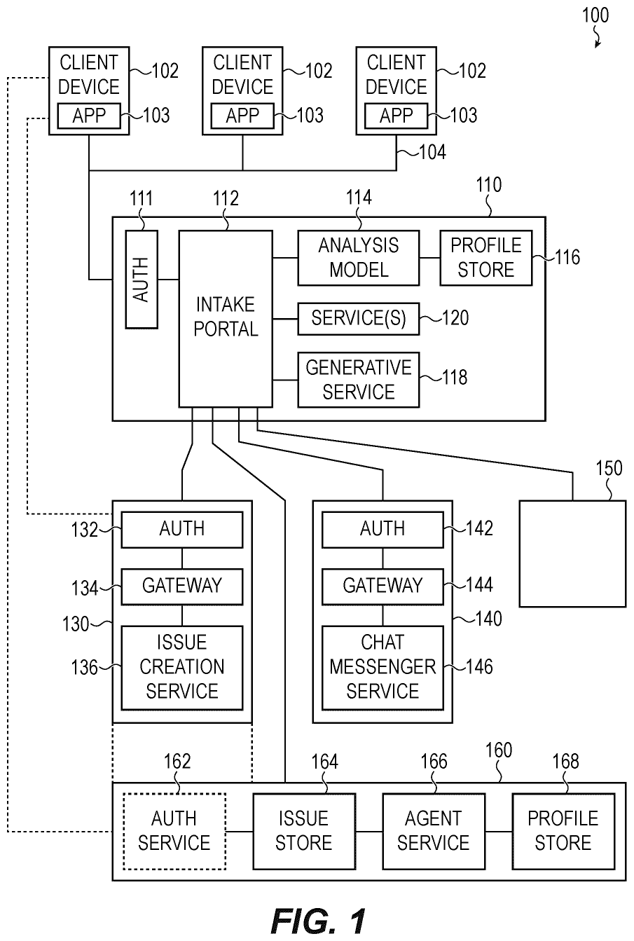

These and other embodiments are described below with respect to FIGS. 1-12. The following examples provides example systems and techniques for providing graphical user interfaces and routing user queries through a system adapted to provide technical support for an application or software product. The systems and processes described in the following examples are illustrative in nature and are not intended to limit the scope of the claims to the specific example embodiments.

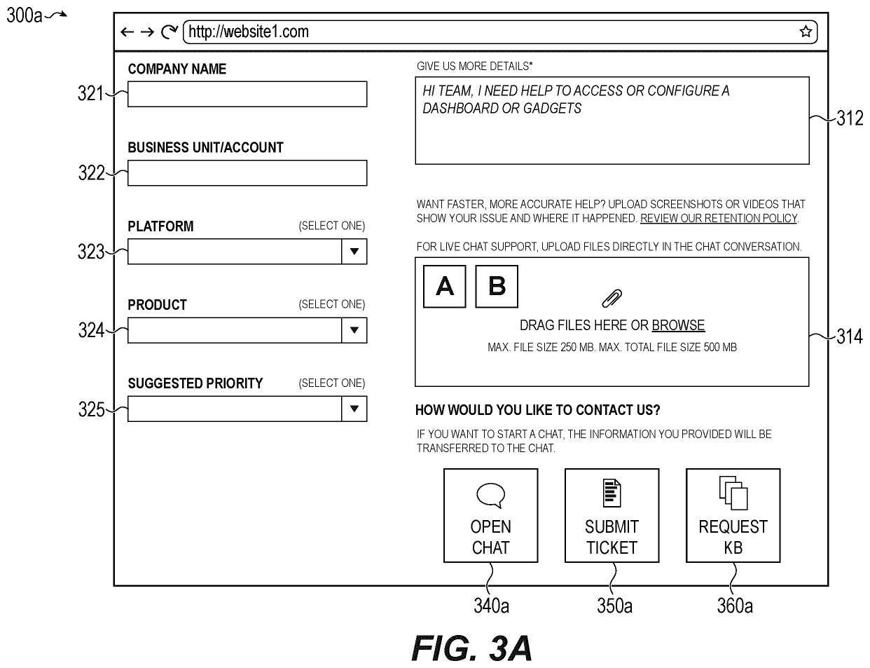

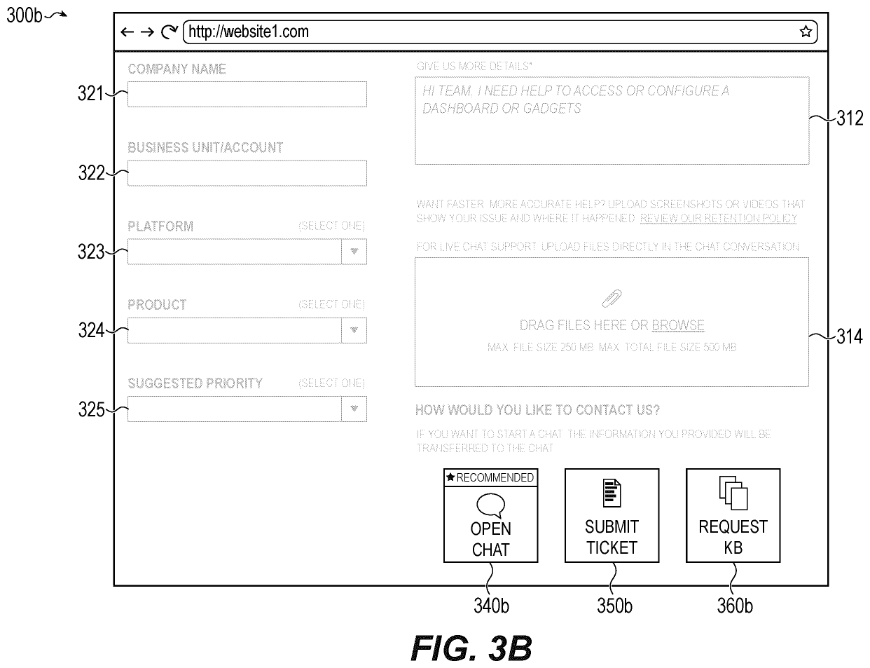

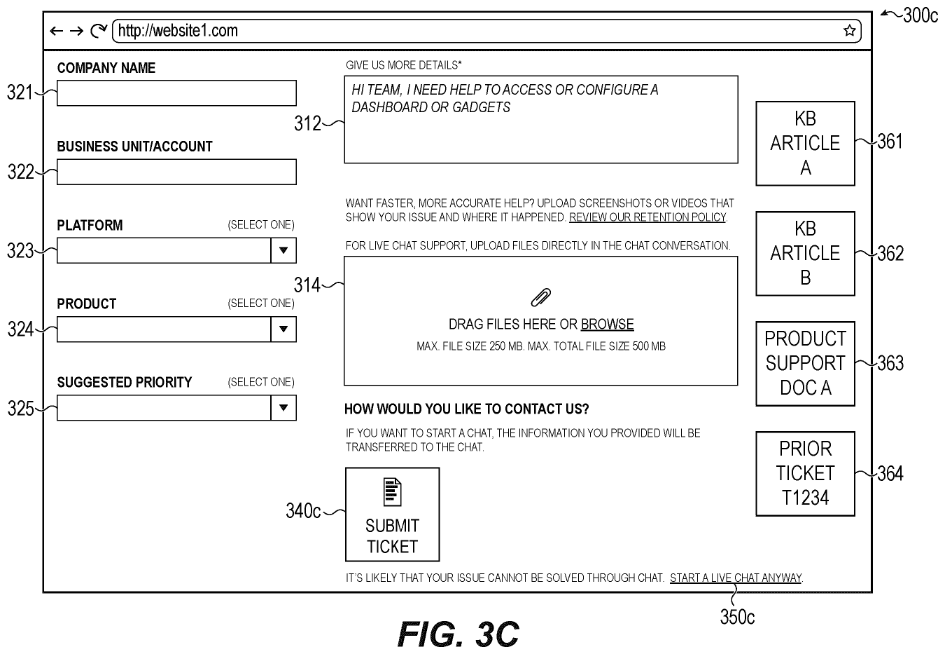

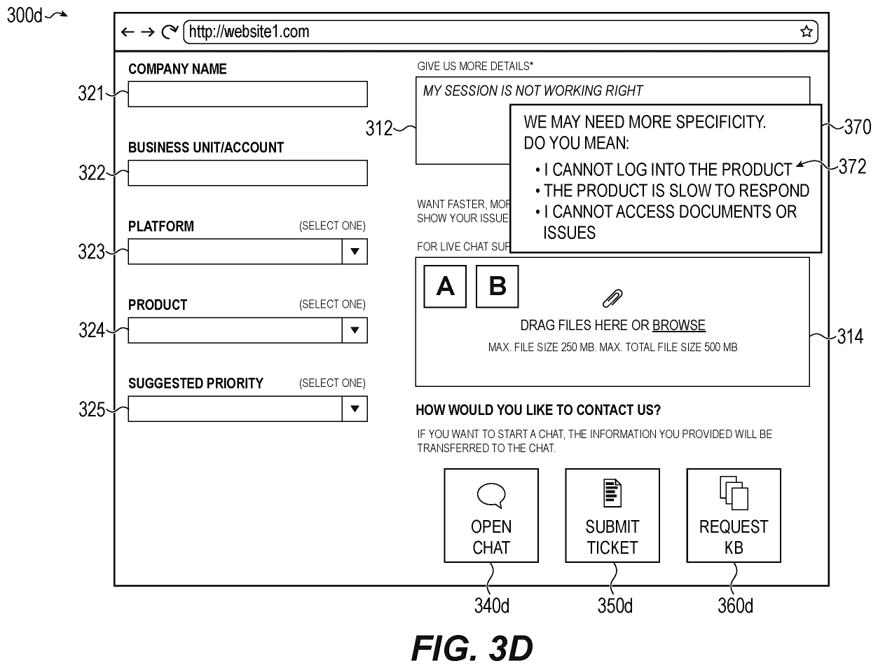

FIG. 1 depicts a system 100 for operating an issue intake portal as described herein. In particular, FIG. 1 depicts a networked computer system that provides access to an issue intake portal via a client application 103 operating on a respective client device 102. The issue intake portal 110 may be used to provide technical support using one or more networked computing services including an issue tracking platform 130, a chat platform 140, or another platform 150, which each include a respective gateway 134, 144 and respective service 136, 146. The issue intake portal 110 includes a backend instance 112 that provides content for the intake portal graphical user interface displayed on the client application 103 on the client device 102. Example intake portal graphical user interfaces are described below with respect to FIGS. 3A-3D. The examples provided herein refer to the use of an intake portal and an intake portal graphical user interface. However, the intake portal may also be more generally referred to as an “intake interface” or simply an “interface.” The examples described herein are not limited to intake portals or one or more of the particular implementations depicted in the illustrative embodiments.

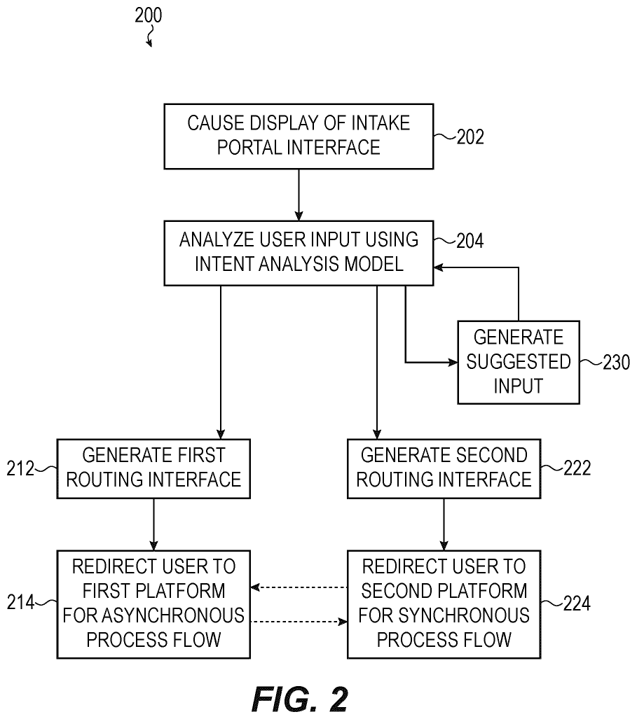

As described herein, the system 100 can be used to direct a user to the most efficient or effective use of system resources based on an analysis of user input including a natural language input received at a client application 103 operating on a client device 102. The user input may be analyzed using an intent analysis model 114, which can be used to determine or predict a query intent, which is used to modify the graphical user interface. In some implementations, the query intent corresponds to a need for an asynchronous interface, a need for a synchronous interface, or a need for other computing resources that may be used to address the user query or request. The output of the intent analysis model 114 may include a set of intents, each intent corresponding to a class of interfaces or type of process flow. Each intent of the set may also include a degree or strength of intent signal, which may be represented by a gradient, confidence score, or other quantitative measure of the predicted intent. As described in more detail below with respect to FIGS. 2 and 3A-3D, the relative strength of each intent signal may be used to generate a modified graphical user interface, which may be used to direct the user to one of a number of platforms and other system resources.

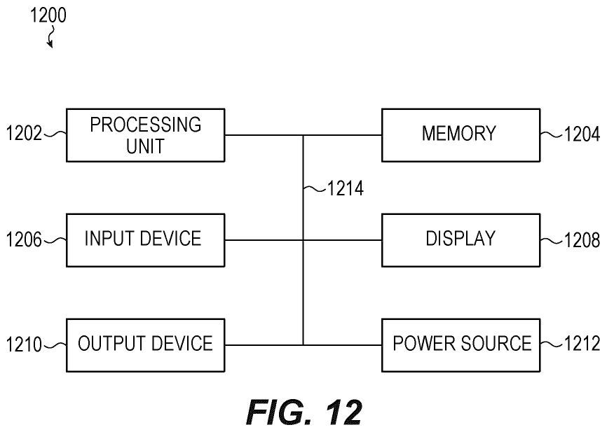

In the present example, a user interacts with the system 100 using a client device 102 that operates or hosts a client application 103 that may include a dedicated client application or may be a browser that is able to access and render web-enabled content. The client device 102 includes a processing unit, display, computer-readable memory and other hardware components that enable the operation of the client application 103. Similar hardware for an example device is described in more detail below with respect to FIG. 12. The client application 103 may include a browser application which may operate or provide a frontend instance or application of the intake portal, an issue tracking platform, a chat platform, or other platform of the system 100. Alternatively, the client application 103 may be a dedicated client application that is configured to provide a frontend instance of application of any of the aforementioned platforms.

Each of the client applications 103 may be adapted to authenticate a user with respect to the intake portal 110, the issue tracking system 130, and one or more of the other platforms over the network 104. Generally, the intake portal 110 may allow the user to submit queries, monitor the status of existing queries, edit previously submitted queries and/or perform various other actions in accordance with a set of permissions associated with the authenticated user. The permissions and other user data may be stored in a client profile store 116. The intake portal 110 or other aspect of the system may include or may be operably coupled to an authentication/authorization service 111, which may authenticate a user based on user credentials, which may include a username or other user identification, password or pin, biometric data, or other user-identifying information. The user credentials may be stored and tracked using a token, authentication cookie, or other similar data element. The authentication/authorization service 111 may also include or use a single-sign on service, in which multiple platforms or services leverage a single or common authentication operation for the user, which may avoid having to authenticate a user separately for each platform or service. Upon successful authentication/authorization of a user, the intake portal 110 or issue tracking platform 130 may access a user profile module 116 to obtain a user profile associated with an authenticated user of a client device. The user profile associated with the user may define various permissions of a user including permissions for creating, editing, accessing, searching, and/or viewing various electronic documents, pages, or electronic content. The user profile associated with the user may also identify other details of the user, including but not limited to, a role of a user in an organization, one or more groups to which a user is a member, other users of the one or more groups to which the user is a member, one or more projects related to the user, one or more issues or tickets (managed by an issue tracking system) the user is assigned to, and so on. The user profile may include, but not limited to, user permission settings or profiles, and user history that may include user logs or event histories, system settings, administrator profile settings, content space settings, and other system profile data associated with the backend applications described herein and associated with the user.

In the example system 100 of FIG. 1, the intake portal 110 is depicted as a separate service that provides access to an intake portal backend or service 112 and other services including an intent model or transformer 114, generative services 118, and other services 120. However, in some implementations, the intake portal 110 is a service that is provided by the issue tracking platform 130 that is operably coupled to an issue tracking backend 160. That is, a client device may interface with an issue tracking platform using either the intake portal 110, the issue tracking platform 130, or with an issue tracking backend 160 depending on the level of access provided to the user and system settings configurable by an administrator. Using the intake portal 110, the user may also access a chat or messaging platform 140 and other platforms 150 via respective gateways 144, 154 or through a web service that provides a respective interface, which may be provided to the user via the intake portal 110. The client device 102 may also access each of the chat or messaging platform 140 and other platforms 150 directly using a web interface or direct client-server communications over the network 104.

In the example system 100 of FIG. 1, the intake portal 110 includes a main intake portal service or backend 112, which may communicate with the frontend or client application 103 to provide one or more of the graphical user interfaces, described herein. The intake portal backend 112 may be configured to process user input (natural language and user selections) and route the requests to various other aspects of the system 100. The intake portal backend 112 may include a service that is adapted to provide web-enabled services to the client applications 103 that enable the operations conducted via the graphical user interfaces described in the various examples, herein.

The intake portal 110 also includes an intent model or transformer 114 which may be adapted to provide an output (e.g., a set of confidence scores or intent signals) based on an analysis of a natural language input provided by the user. The model 114 may include a pre-trained transformer that has been trained using prior ticket data or issue data from previously completed tickets or issues processed by the issue tracking platform 130. The model 114 may also be trained using a set of tokens that may include a set of application-specific tokens, tenant-specific tokens, or other specialized terms or tokens. The model 114 may then be built into a classifier using the training data and other classifier data. The model 114 may be built using one of a variety of different transformer or language models including a bidirectional encoder representation and transformer model (BERT), encoder-decoder recurrent neural network models, large-language models, and others. As described previously, the model 114 may be adapted to produce a set of intent signals that indicate a strength of a correlation with a particular process flow or interface, which may be characterized as synchronous, asynchronous, user-directed, or other type of characterization. In accordance with the output of the model 114, the intake portal 110 may provide a modified graphical user interface that provides options for routing the user through the system in accordance with what is predicted to be the best response to the query.

The intake portal 110 may also include a set of client profiles or user profiles managed or stored in profile store 116, which may be used to reference a role, user permissions, or other data that corresponds to an authenticated or identified system user. In one example, the user profile store 116 includes data that indicates a level of technical sophistication or expected technical comprehension of the user and can be used, in combination with the natural language user input, to analyze the user's query and produce a modified graphical user interface. For example, the user profile store may include a technical rating or technical classifier that is associated with a user or a user role. A user that has a profile setting that indicates that the user may have a role associated with a certain level of expertise or knowledge, the intake portal 110 and/or the model 114 may bias the results to provide a process flow that allows the user to troubleshoot the problem quickly either through a synchronous process flow or a user-directed process flow. The user profiles 116 may also include user histories, event logs, prior ticket resolutions, user preferences, and other user-specific data.

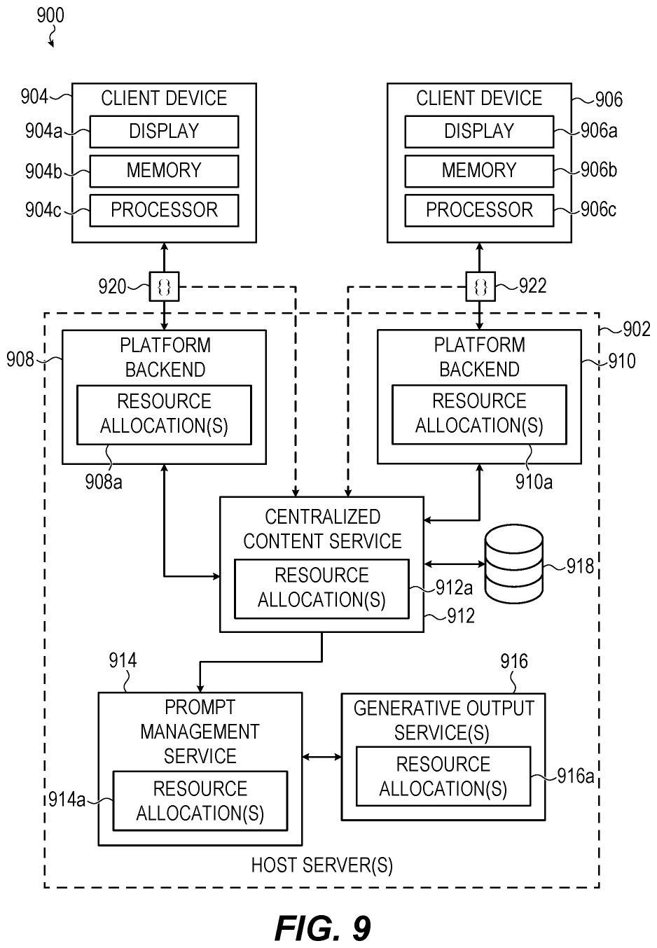

The intake portal may also include or have access to generative services 118, which may be used to suggest alternative query phrases or follow-up questions, which may be displayed to the user in the application 130. In one example implementation, in response to an output of the intent analysis model 114 indicating a weak or ambiguous user intent, the system 100 may cause generation of a prompt using or sent to a generative service 118, which is adapted to produce a set of one or more suggested queries that can be displayed to the user for selection and/or further editing. A weak or ambiguous intent may be detected in response to a set of confidence scores that fail to satisfy an intent threshold or other intent criteria. As described in more detail below with respect to FIGS. 9-11B, a generative service uses at least a portion of the user's natural language input and predetermined prompt language, which may include a request for an improved query, to construct a prompt that is provided to a generative output engine. The generative response produced in response to the prompt may be used to generate one or more suggested queries or follow-up queries, which may be selected and adopted by the user in the graphical user interface to submit a new or modified query to the intake portal 110. The generative services 118 may also be used to automatically modify, rephrase, or reformulate a query in response to a determination that the natural language input results in a weak or ambiguous intent. The modified or reformulated query may be provided to the intent analysis model 114 and processed similar to originally entered user text. In some cases, the system 100 may iterate and provide multiple rounds of modified or reformulated queries (with or without user-provided edits) until an intent criteria is satisfied.

The intake portal 110 may also include other modules or services 120. The other modules or services may be used to help process user input and may include one or more natural language processing services. For example, the services 120 may include a pre-processing natural language service that processes the natural language query or other user input before being processed by the intent analysis model 114. In some implementations, the services 120 may also provide post-processing analysis on an output from the intent analysis model 114, which may include an analysis of intent signals including, for example, the relative magnitude or scale of a set of confidence scores produced by the intent analysis model 114. The services 120 may also include services for accessing, ranking and producing documentation that is identified using the natural language user input and/or an output from the model 114. The documentation or other electronic content may be provided by platform 150, which may include a content collaboration platform, such as a documentation platform or knowledge base platform. The services 120 may provide other services or modules consistent with the systems and techniques described herein. While only a single element 120 is depicted in the example of FIG. 1, multiple distinct elements may be used in a particular implementation or configuration of system 100.

As shown in FIG. 1, a set of platforms 130, 140, 150 may be operably coupled to the intake portal 110 and one or more of the client devices 102 via the computer network 104. Each of the platforms may provide a service in support of the intake portal 110 and may provide a graphical user interface in response to a user selection of a corresponding selectable graphical object of the intake portal graphical user interface. Each platform 130, 140, 150 may be associated with a particular class of response or process flow predicted to correspond to the user input provided to the graphical user interface provided by the intake portal 110. For example, the issue tracking platform 130 may be associated with a response classified as an asynchronous process flow and the chat platform 140 may be associated with a response classified as a synchronous process flow. The platform 150 may include a content collaboration platform like a documentation platform or knowledge base, which may be associated with a response classified as a user-directed or self-help process flow.

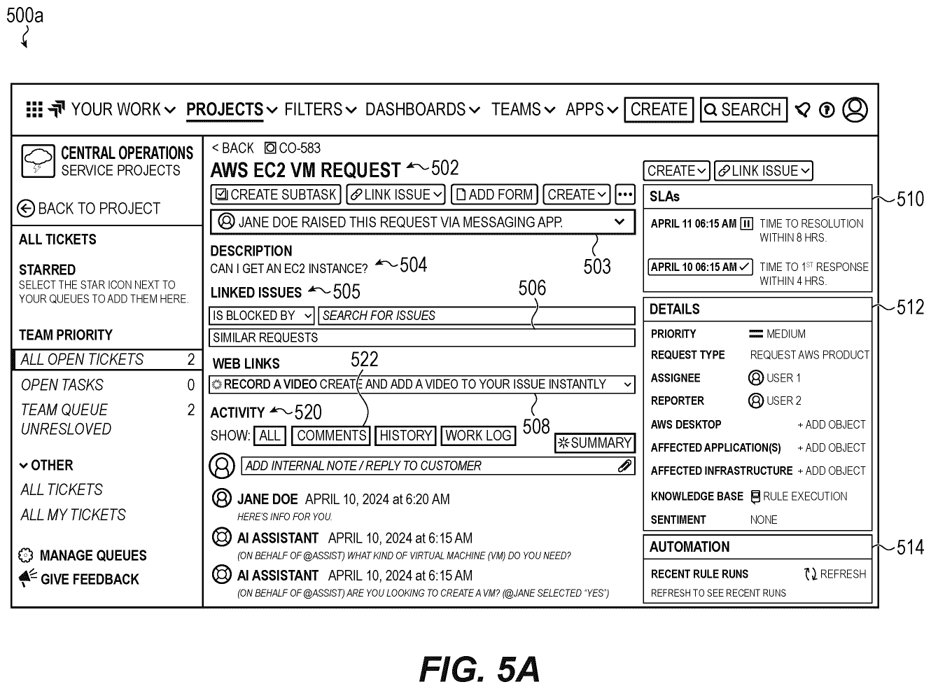

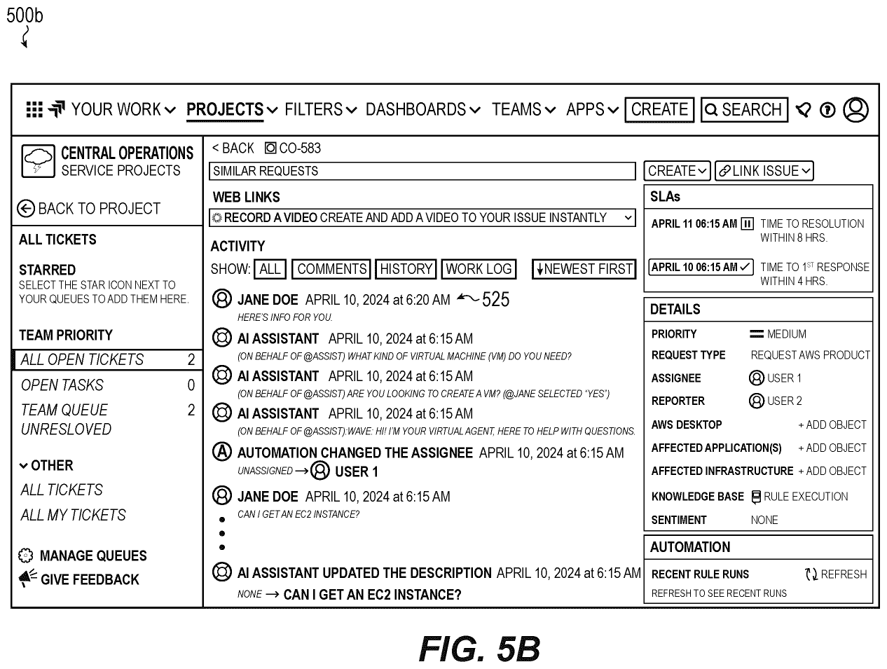

In the current example, the platform 130 is an issue tracking platform that is configured to generate and process issues or tickets that may be initiated or created in response to a user query or other user input. In general, the issue tracking platform 130 generates and processes issues or tickets in accordance with a predetermined or predefined issue workflow, which defines a series of states through which the issue or ticket must progress before the issue or ticket can be closed or completed. Each of the issues or tickets may be defined by a corresponding issue object having a set of fields and attributes that are used to process the issue. An example issue tracking platform is described in more detail below with respect to FIGS. 5A-8.

In the present example, the issue tracking platform is represented by two elements, specifically, platform 130 and backend system 160. While various elements and services are depicted as being operated as part of one of the elements 130, 160, many of the elements and services can be operated by either or both of the elements 130, 160. In some implementations, there is no distinction between the platform 130 and the backend system 160 and the two elements are operated as a single platform or monolith, as depicted by the dashed lines connecting the elements 130, 160 in FIG. 1.

As shown in FIG. 1, the platform 130 includes an authorization service 132, which may conduct an authentication process or confirm a previously conducted authentication before providing access to the issue tracking platform 130, via the gateway 134. The authorization service 132 may operate independently of the authorization service 111 described above and implement an authorization process similar to the processes described above with respect to service 111. The authorization service 132 may also leverage a previously conducted authorization process, which may have been performed by authorization service 111 or another similar service. In the current example, the platform 130 also includes a gateway service 134 that is configured to process and route inbound requests from an authenticated user or service. For example, the gateway service 134 may process incoming advanced programming interface calls from the intake portal 110 or other element and direct the requests to the appropriate service or element of the issue tracking platform 130 and/or the backend 160. The gateway 134 may perform a validation of the inbound calls and ensure that the requesting service or user has the appropriate permissions to access the associated operations of the system.

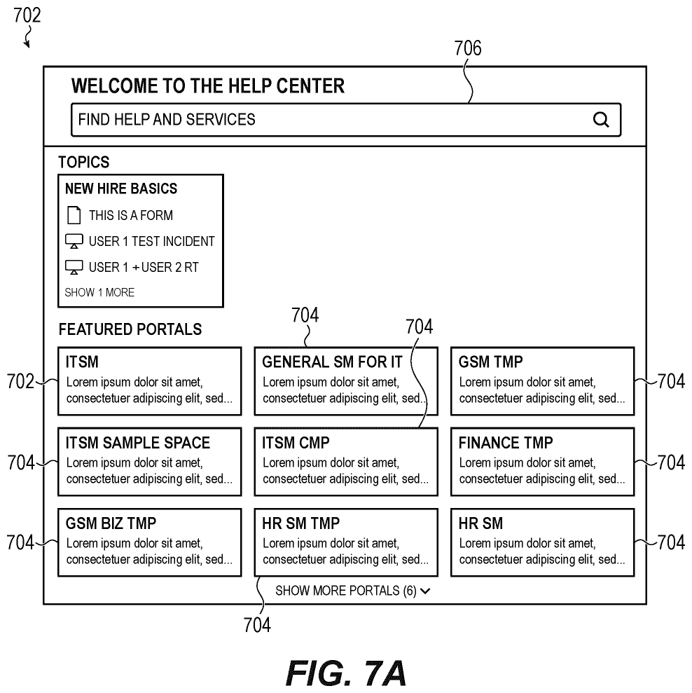

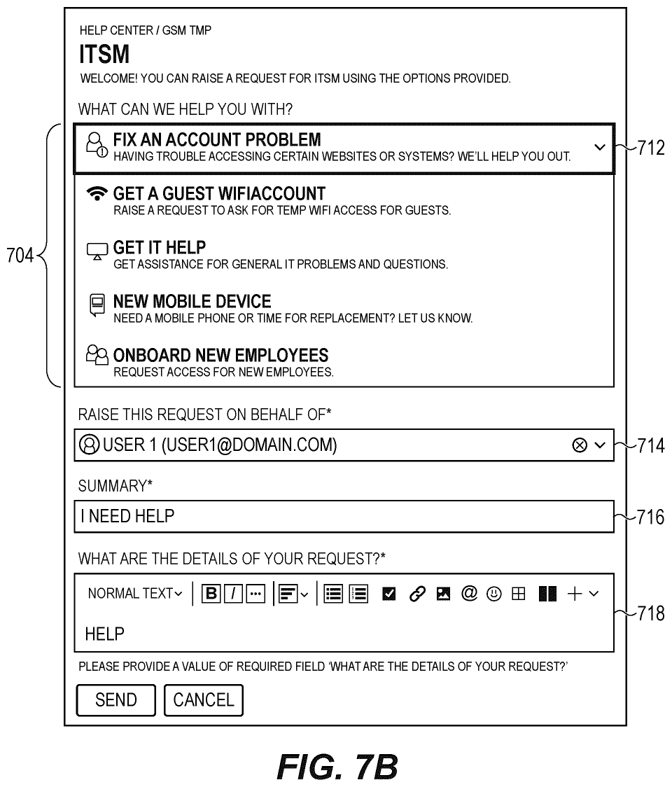

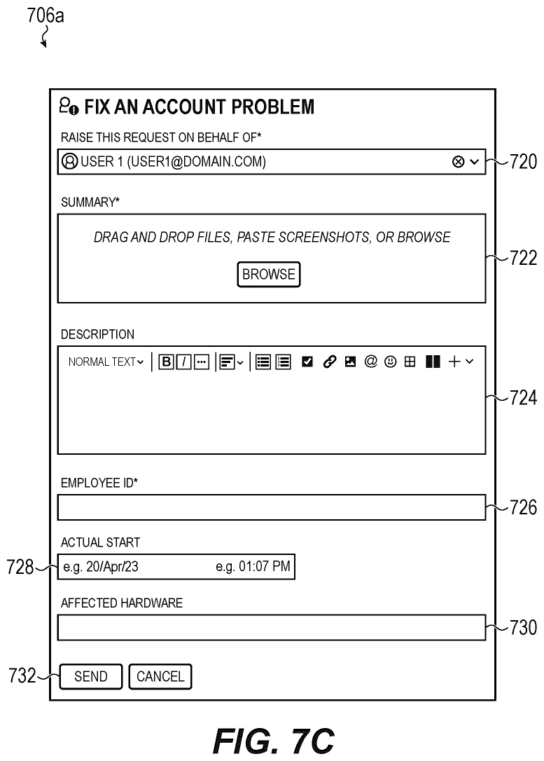

The platform 130 also includes an issue creation service 136, which may provide the graphical user interface for generating a new issue or ticket. An example graphical user interface is depicted in FIGS. 7B and 7C, described below, and may include a set of fields and elements for receiving user input and/or imported content used to generate a new issue or ticket. The issue creation interface may be operated in response to a determination by the intake portal 110 that the request is to be handled in accordance with an asynchronous process flow and as selected by the user in the intake portal graphical user interface. As described herein, the graphical user interface may be caused to be displayed on the client device 102 by the system in response to a user selection of a corresponding graphical object provided by the intake portal 110. In some implementations, a portion of the new issue content may be pre-populated by the system 100 using data extracted from the user input or other data obtained by the intake portal in response to the user input. In this way, the user may experience a seamless or streamlined user interface that reduces the entry of redundant information and/or leverages data associated with a type of request or class of inquiry associated with the user request.

In response to the creation of a new issue or ticket, the platform 130 may store the new issue or ticket object in the issue store 164 of the backend 160. The issue or ticket object may then be processed in accordance with an associated workflow, which may transition the issue or ticket object through a series of states or issue statuses as the issue or ticket is processed to a resolution or closure. As part of processing the issue or ticket object, the backend 160 or other aspect of the issue tracking system may provide an agent service 166 or interface which allows a technician or other system user to review the issue content and provide the requested service or set of operations. The agent service 166 may include an automated agent or automated operations which assist with the processing of the issue or ticket object. The agent service 166 may also include an interface or series of interfaces with a user agent or system user that assists with the processing of the issue or ticket object. Example interfaces are depicted in FIGS. 5A, 5B, 7A-7C, described below. In some implementations, the system 100 may extract data from or analyze issue or ticket data stored in the issue store 164 which may include previously completed issues or tickets and/or issues or tickets being processed by the system 100. In some cases, the issue or ticket data is used to train the model 114 to help classify inbound requests in accordance with prior system usage and successful outcomes.

As shown in the example system 100 of FIG. 1, a system user may directly access either the issue tracking platform 130 or the backend 160 from a client device 102. As previously discussed, a user may be authenticated by either of the authentication services 132, 162 before being granted access to content and operations of the issue tracking platform 130 or backend 160. The user may be a requesting user, who may access the platform 130 or backend 160 in order to check the status of an issue or ticket or provide additional information or issue content in order to assist processing of the issue or ticket object. The user may also be an agent or other user having authorization to address the technical problem or other operations associated with the issue or ticket object.

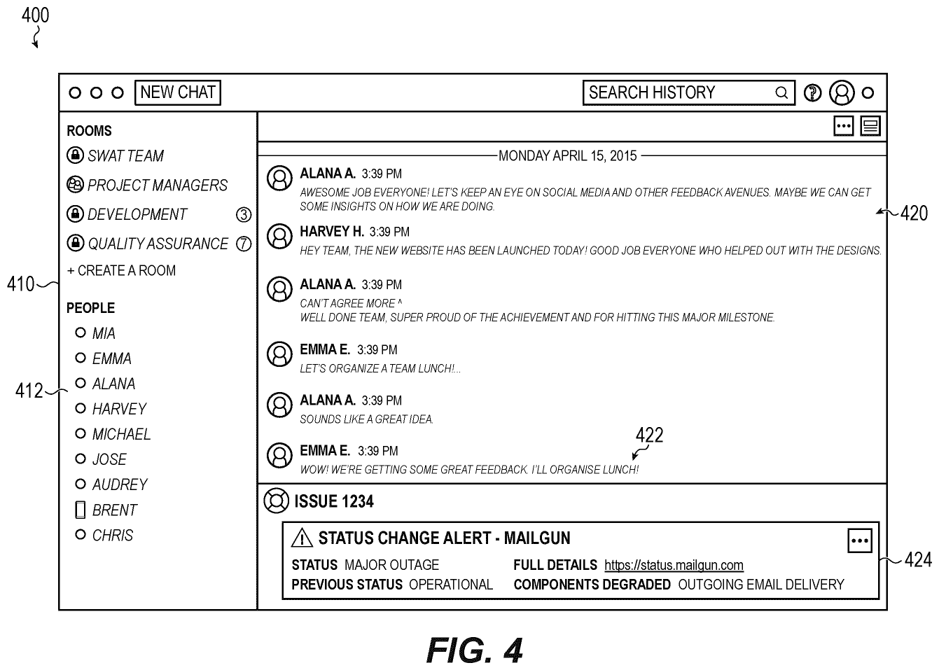

As shown in the example system 100 of FIG. 1, the intake portal 110 may also interface with and/or redirect the user to a chat platform 140 also referred to as a messaging platform or communication platform. Similar to as described with respect to the issue tracking platform 130, the chat platform 140 includes an authentication service 142 for performing authentication or confirming authentication of a user or service. The chat platform 140 also includes a gateway 144 for routing inbound requests, which may include directing the inbound requests (e.g., application programming interface calls) to an appropriate chat channel, message board, or other aspect of the chat platform 140. The chat platform 140 also includes a chat messaging service 146, which may operate a chat interface between two or more users participating in a chat or messaging session. An example messaging interface is depicted in FIG. 4, described below. The messaging interface may be operated in response to a determination by the intake portal 110 that the request is to be handled in accordance with a synchronous process flow and as selected by the user in the intake portal graphical user interface.

In the example system 100 of FIG. 1, the platform 150 represents other platforms or system services that can be used to facilitate the processing of a user inquiry or request. As mentioned previously, the platform 150 may include a content collaboration system that may include a documentation system, knowledge base, or other content management system. The platform may provide electronic documents, pages, or other electronic content in response to requests from the intake portal 110, client devices 102, or other elements of the system 100. The platform 150 may represent other types of platforms including, for example, a user directory, project wiki or project documentation platform, project management platform, codebase or code management system, or other type of system or platform. The platform 150 may also include an authentication service, gateway, interface or other service similar to as described herein with respect to other aspects of the system 100, a description of which is not repeated to reduce redundancy.

All services, platforms, and other elements of the system 100 may operate on one or more computer systems or other hardware platforms. An example hardware configuration is described below with respect to FIG. 12 and illustrates how one or more processing units and computer-readable memory may be used to store instructions for performing various operations and functions described herein with respect to FIG. 1 and other aspects of the present disclosure. Each platform or element may be operated on a distinct hardware platform or using distinct designated resources of a hardware platform in order to perform the described operations and functionality. In some cases, two or more platforms or elements may share hardware or designated resources depending on the implementation and configuration of the corresponding hardware.

FIG. 2 depicts an example process flow diagram for processing a user request submitted to an issue intake portal. In particular, the process 200 includes a set of example operations that may be performed using an intake portal and two or more platforms for processing a user request or inquiry in accordance with the present disclosure. As described previously, the intake portal can be used to analyze a natural language user input and along with other factors, may use an intent analysis model to predict or estimate a degree of intent with respect to a classification of the type of response needed to address the user query. The operations of process 200 are directed to a classification of a user query with respect to two classifications: (1) an asynchronous process flow associated with a first platform and (2) a synchronous process flow associated with a second platform. However, process 200 can be adapted to handle more than two classifications and may be used to redirect the user to a variety of different platforms in addition to the ones specifically provided in this example embodiment.

In operation 202, an intake portal graphical user interface is displayed on a client device. The intake portal graphical user interface may include a text input region that is configured to receive user input, typically in the form of text or including one or more natural language strings. The intake portal graphical user interface may also include a variety of other graphical objects and input elements that the user can select to provide input. The graphical user interface also includes a first graphical object selectable to cause redirection of the graphical user interface of a first platform. In the present example, the first platform may be an issue tracking platform, which may produce an issue creation interface for generating a new issue to address the user query. The graphical user interface also includes a second graphical object selectable to case redirection of the graphical user interface to a chat interface of a chat platform. An example graphical user interface is described below with respect to FIG. 3A.

In operation 204, the user input is analyzed using an intent analysis model to obtain a set of intent signals. In some implementations, the intent signals include a set of confidence scores, each indicating a degree or relative measure of a strength of intent with respect to a particular process flow classification. In the present example, the confidence scores may correspond to a first classification associated with an asynchronous process flow and a second classification associated with a synchronous process flow. The confidence scores may also include a third confidence score indicating or associated with a user-directed process flow. As described herein, the confidence scores may also be used to evaluate the analyzed input with respect to various criteria, which may compare the relative magnitude or strength of the various scores or intent signals to cause the system to modify the interface or perform other operations. For example, the intent signals (e.g., confidence scores) may be evaluated with respect to a synchronous criteria associated with the synchronous process flow, an asynchronous criteria associated with the asynchronous process flow, or a user-directed criteria or knowledge intent criteria associated with a user-directed or self-help process flow. In some implementations, the intent signals may be evaluated with respect to an ambiguity criteria which may signal weak or insufficiently detailed user input and used to trigger a process for generating suggested input or language, which may be adopted by or modified by a user for a subsequent inquiry.

As described previously, the intent analysis model may include a transformer machine learning model that is trained using past user inquiries, issue or ticket data, and resolutions. Specifically, the intent analysis model may be trained using issue or ticket object data stored by the issue tracking platform during the processing of previous issues or ticket objects and may include training using attribute data, issue content, and other data elements generated during the processing of the issues or tickets. The data may also include data extracted from event history logs which may include a number of interactions with a particular platform and an outcome or indicia of resolution with respect to the issue and an associated platform. The event history logs may also include an indication of a time interval for issue resolution and may include an indication of a number of sessions for a particular platform or platforms utilized to achieve issue resolution. Prior data that is used to train the model may be stripped of personally identifiable information, confidential information, or other potentially sensitive information to allow the data to be used across different customers or tenancies.

The tickets may also include a process flow classifier or other data element that corresponds to a classification as either an asynchronous or synchronous process flow. The model may also be adapted to include specialized vocabulary, company-specific or product-specific terminology and embeddings for adapting the use of the model with a particular product support scheme. For example, if the intake portal interface is being used to support a set of software products, the model may be trained using specialized terms used to describe and support a class of features provided by those software products. The model may include a bidirectional encoder representation transformer that is adapted to represent text as a series of vectors or other encoded representations. In such an implementation, vectorization and, in some cases, embedding operations may be performed on the user input before applying the intent analysis model.

In some implementations, the intent analysis model is trained using issues associated with a particular tenant or customer in order to produce a tenant-specific model. By using issue or ticket data generated by the particular tenant or customer, the intent analysis model may be adapted to classify an inquiry in a way that is consistent with prior system use for that particular tenant or customer and may accommodate company-specific or industry-specific vocabulary and phrasing. Further, using a tenant-specific model, it may not be necessary to strip company-specific or potentially confidential or sensitive information out of the training data set. The tenant-specific model may be made available only in response to a successful authentication of a user associated with the given tenant or company. For example, in response to an authenticated user of the client device being associated with an account of the particular tenant, the tenant-specific model may be selected for use or adopted as the intent analysis model. In response to the authenticated user of the client device being associated with an account of a second tenant different than the particular tenant, a different model may be selected or adopted for use as the intent analysis model. The different model may be another tenant-specific model or may be a tenant-agnostic model.

As a result of operation 204, a set of confidence scores may be obtained, which may be used to reconfigure the graphical user interface in accordance with one of a set of process flows. The set of confidence scores may include a first confidence score corresponding to a first intent for an asynchronous interface, and a second confidence score corresponding to a second intent for a synchronous interface. While two confidence scores are described in detail in this example, additional confidence scores of additional information may be produced by the model to provide additional options or optional process flows including self-directed process flows, hybrid process flows, or other processes for resolving the user query.

As shown in FIG. 2, in response to the first confidence score exceeding the second confidence score by a first threshold value, a first routing interface may be generated in operation 212. The first routing interface may include a modified intake portal graphical user interface in which some selectable options may be emphasized and other selectable options may be deemphasized or suppressed from display. As shown in the example of FIG. 3C, generating the first routing interface may include suppressing display of the second graphical object associated with a synchronous interface and maintaining the display or visually emphasizing the display of the first graphical object associated with an asynchronous interface. Operation 212 may be performed in response to the analysis of the set of confidence scores indicating that the problem complexity or resolution is predicted to be most efficient or robust using an asynchronous process flow that leverages, for example, an interface associated with an issue tracking platform.

In operation 214, the user may be redirected to the first platform for an asynchronous process flow. Specifically, in some instances, in response to a user selection of the first graphical object, the system may cause display of the issue creation graphical user interface of the issue tracking platform, which may be used to create a new issue or ticket in the issue tracking platform. An example issue creation graphical user interface is described below with respect to FIGS. 7A-7C. Creation of the new issue may initiate an asynchronous process managed in accordance with workflow defined in the issue tracking platform. This may allow for the resolution of more complex inquiries or for problems that require multiple resources, for which an asynchronous process flow using the issue tracking platform may be well adapted.

As shown in FIG. 2, in response to the second confidence score exceeding the first confidence score by a second threshold value a second routing interface may be generated in operation 222. The second routing interface may include a modified intake portal graphical user interface in which some selectable options may be emphasized and other selectable options may be deemphasized or suppressed from display. For example, generating the second routing interface may include suppressing display of the first graphical object associated with an asynchronous interface and maintaining the display or visually emphasizing the display of the second graphical object associated with a synchronous interface.

As shown in the example of FIG. 3B, generating the second routing interface may include maintaining display of the first graphical object associated with an asynchronous interface and visually emphasizing the display of the second graphical object associated with a synchronous interface. Operation 222 may be performed in response to the analysis of the set of confidence scores indicating that the problem complexity or resolution is predicted to be most efficient using a synchronous process flow that leverages, for example, an interface associated with a chat or messaging platform.

In operation 224, the user may be redirected to the second platform for a synchronous process flow. Specifically, in some instances, in response to a user selection of the second graphical object, the system may cause display of the chat or messaging user interface of the chat platform, which may be used to conduct a chat or messaging session with an agent or service. An example chat or messaging graphical user interface is described below with respect to FIG. 4. This may allow for rapid resolution of more simple or routine inquiries or for problems that can be handled with an immediate electronic exchange, for which synchronous process flow using the chat or messaging platform may be well adapted.

In some implementations, content obtained from the user (including the natural language user input), data produced using the intent analysis model, and content extracted from previously processed or current tickets or issues may be used to pre-populate elements in either the first platform or second platform graphical user interfaces. For example, in the scenario in which the graphical user interface is redirected to the first platform (e.g., an issue tracking platform) content obtained from similarly classified issue or ticket objects may be extracted and used to pre-populate one or more corresponding fields of the issue creation graphical user interface. At least a portion of the natural language user input may be extracted and used to pre-populate a description or other similar field in the issue creation graphical user interface. In some implementations, data extracted from previous tickets and at least a portion of the natural language user input is provided, in a text prompt, to a generative service with predetermined prompt language requesting for a set of suggested text strings corresponding to a set of fields of the issue creation interface or form. The suggested text strings may be pre-populated in each of the respective fields in response to a redirection to the issue creation graphical user interface. The pre-population of the respective fields may be accomplished using an application programming interface call provided to a gateway or other aspect of the issue tracking platform. In a similar fashion, content may be provided to the second platform (e.g., a chat or messaging platform) to prepopulate message content or other fields or elements in the chat or messaging interface. In one example, a portion of the natural language content or generative content produced using a generative output engine may be pre-populated in a user message by using an application programming interface call provided to a gateway or other aspect of the chat or messaging platform.

The process 200 described with respect to FIG. 2 is directed to an initial classification or routing of a user to one of two respective platforms to initiate an asynchronous or synchronous process flow, respectively. However, as shown in FIG. 2, regardless of the initial routing, a user may opt to perform some or all of a remaining set of operations on the other of the two platforms, as indicated by the connectors between operations 214 and 224. For example, the respective graphical user interfaces may include a selectable graphical object that is selectable to cause redirection of the interface to the other platform. Additionally or alternatively, the user may return to the intake portal graphical user interface and use the respective selectable graphical objects to transition to the other platform.

Further, as described in more detail below with respect to FIG. 3D, in response to the analysis of the user input satisfying an ambiguity criteria, the process at operation 230 may generate one or more suggested input, which may be adopted, edited, or modified by the user for further processing. The ambiguity criteria may be satisfied if the set of intent signals is too weak, as indicated by a set of values that are below an ambiguity or signal threshold. The criteria may also be satisfied if the analysis model fails to produce an output that meets a utility criteria or other indication that the output of the model is not satisfactory or reliable. In some cases, the ambiguity criteria may also rely on semantic analysis or word count of the natural language user input, which may be used to indicate incomplete sentences, ambiguous or poorly phrased strings, and/or nonsensical entries. Described in more detail below with respect to FIG. 3D, a generative output engine, including a large language model, may be used to generate a set of suggested queries, follow-up queries, and/or clarifications that can be adopted or modified by the user for reanalysis in operation 204.

FIGS. 3A-3D depict an example intake portal graphical user interface that is modified in response to user input in order to direct the user to a particular platform in accordance with the output of an intent analysis model. As described previously, a natural language user input, alone or in combination with other user-specific or session-specific data may be processed using an intent analysis model to produce a set of confidence scores or other intent signals. Based on the relative strength of the intent signals (e.g., confidence score values), the intake portal graphical user interface is modified. The modified user interface may be adapted to direct the user to a particular platform to perform particular process flow. In the examples described below with respect to FIGS. 3A-3D, the platforms include an issue tracking platform associated with an asynchronous process flow, a chat or messaging platform associated with a synchronous process flow, and a documentation platform or knowledge base platform associated with a user-directed or self-help process flow. Other implementations may use different or additional platforms that are adapted to assist the user using a respective process flow while using a similar technique as described with respect to FIGS. 3A-3C

FIG. 3A depicts an intake portal graphical user interface 300a for receiving user input and directing the user to a platform associated with a respective process flow. Specifically, the graphical user interface 300a of FIG. 3A depicts a text input region 312 that is configured to receive user input. The text input region may include an editor that is configured to allow entry and editing of text and, in some implementations, rich text that includes non-text symbols, elements, and other graphical objects. The interface 300a also includes a set of selectable graphical objects 340a, 350a, 360a, that may be displayed in accordance with an analysis of the user input along with other user-specific or session-specific data items. In the present example, the graphical objects 340a, 350a, 360a are displayed prior to receiving user input in order to provide the user a visual indication of the various available process flows that can be used to resolve a query. However, in another implementation, one or more (or all) of the graphical objects 340a, 350a, 360a may be suppressed from display or hidden until a user provides input and the system analyzes the input to determine a recommended process flow.

As shown in FIGS. 3A-3C, the intake portal graphical interface is modified based on the relative strength of a set of intent signals to direct the user through the system in accordance with a predicted process flow. In the present example, the first graphical object 350a is selectable to cause redirection of the graphical user interface 300a to an issue creation interface of an issue tracking platform. An example issue creation graphical user interface is depicted in FIGS. 7A-7C. The second graphical object is selectable to cause redirection of the graphical user interface 300a to a chat interface of the chat or messaging platform. An example chat interface is depicted in FIG. 4. The interface 300a also includes a third graphical object 360a, which may be selectable to cause redirection to a documentation platform or knowledge base platform having a document viewer or document browser interface. Selection of the third graphical object may also cause display of one or more additional selectable objects, each object associated with a content item identified using the user input. An example of this type of selectable item is depicted as items 361-364 in FIG. 3C.

The interface 300a of FIG. 3A depicts other types of user input that can be used to modify the interface and/or be passed along to a respective platform. Specifically, the interface 300a includes fields 321-326, which may receive user input associated with a particular category or input type. For example, field 321 may be used to receive an identifier of a company name or client identifier. Similarly, field 322 may be used to receive a subclassification of the company including a business unit or specific account identifier. As shown in the fields 323, 324, 325, the fields may also be adapted to present drop-down menus in response to a user input. The menus may be pre-populated with selectable entries that have been selected in accordance with user input provided to other fields. Field 323 may be prepopulated with platforms that are associated with a particular company or account. Similarly, field 324 may be prepopulated with products which are currently licensed to the specified company or associated with the specified account. In some instances, some of the information expressly entered in the fields 321-324 may be obtained automatically in response to a successful authentication of a system user, which may have a user account that can be used to obtain company, account, platform, and product details. As shown in this example, field 324 also allows the user to specify a suggested priority or urgency for the submitted query. The user may also provide one or more files, including documents, transaction logs, error reports, or other electronic content into droppable field 314. The intake portal may be configured to access content of the uploaded documents and use content extracted from one or more of those documents in order to analyze the user input and modify the interface 300a.

In addition to collecting express input from the user via the interface 300a, the system may obtain a user profile associated with an authenticated user of the client device. As described previously with respect to FIG. 1, a user may be authenticated using an authorization service or a trusted service or platform that is able to verify and authenticate user credentials including a username, password, token, or other authenticating data. Subsequent to authentication, the system may obtain user data that can be used to classify or characterize the level of technical sophistication of the user or other characteristics of the user that may be useful for resolving the query. Example user data includes role-specific data associated with the user role from the user profile. Other user data may include user history, user technical ranking, user job description and other data available from or using the user profile. Additional user data may include user event logs, past ticket history, number of prior queries and resolutions, and other similar system data. This user data along with the user input received expressly in the interface 300a may be provided to the analysis model.

In response to or subsequent to the user providing input to the interface 300a, the system may analyze or process the input and/or other user data using an intent analysis model and produce a set of intent signals. In some embodiments, the intent signals are represented by a set of confidence scores, each score associated with a respective user intent or query classification. Other intent signals may also be used including, for example, degree or correlation, confidence interval, or other quantitative output of the analysis model. Each classification or intent may correspond, for example, with a particular process flow, platform, or interface. As described previously, process flows can be characterized as synchronous, asynchronous, user-directed, or hybrid. Other classifications or characterizations may also be used. In response to or subsequent to an analysis of the user input, the interface may be modified in order to help direct the user to a particular process flow predicted to be helpful or an effective process flow for the user input.

FIG. 3B depicts an example interface 300b that may be generated in response to an analysis of the user input and other user data using the intent analysis model. Specifically, in response to the output of the intent analysis model (e.g., the set of confidence scores) satisfying a synchronous criteria, the interface 300b may include a display of the second graphical object 340b that is visually emphasized with respect to the other graphical objects 350b, 360b. In this example, the graphical depicting of the second graphical object 340b includes a banner or label that indicates that the system analysis predicts that use of the platform corresponding to the second graphical object (e.g., the chat platform) is the most effective process flow for resolving the particular query. The synchronous criteria may be satisfied if a confidence score associated with a synchronous intent exceeds a threshold with respect to a confidence score associated with an asynchronous intent. The set of confidence scores may also be evaluated with respect to an asynchronous intent, which may be satisfied if a confidence score associated with the asynchronous intent exceeds a threshold with respect to a confidence score associated with a synchronous intent. The thresholds may be selected to provide a designed amount of hysteresis or stability in the system to prevent immediate toggling or appearance of unstable results. The various criteria may also incorporate different levels of signal intent or levels of difference between the levels of intent. For example, if a relative difference between two intents is greater than a first threshold level, then a first level of recommendation is presented. Specifically, as shown in FIG. 3B, the interface may provide a visual distinction between one or more of the graphical objects 340b, 350b, 360b. If the relative difference between two intents is greater than a second threshold (which is greater than the first threshold), one or more of the graphical objects 340b, 350b, 360b may be suppressed from display or ceased to be displayed in a respective interface. FIG. 3C depicts an example interface 300c in which graphical objects corresponding to the synchronous process flow and the user-directed process flow are suppressed from display or ceased to be displayed. Nested or tiered thresholds are one way of evaluating the intent criteria but other techniques can also be used including using a gradient, vector analysis, normalized metric, or other techniques.

In some implementations, the company, tenant, or user may provide inputs or a configuration that helps to define the various criteria used to generate the different types of interfaces. For example, a company, tenant, or user may specify a preference for a synchronous, asynchronous, or user-directed process flow, which may be accommodated in the respective criteria by adjusting threshold values, weighting the output of the analysis, and/or using a different evaluation technique. A company, tenant, or user that tends to be more sophisticated may prefer synchronous or user-directed process flows as compared to an asynchronous or ticket-based process flow. Similarly, the time of day or other timing criteria may be used to influence the evaluation of the analysis output in order to direct users to a platform that is available or is most likely to produce satisfactory results given present or predicted staffing. By way of example, if a request is submitted outside of working hours when staffing for chat or messaging services may be limited, the system may be biased toward asynchronous or user-directed process flows.

In some implementations, the interface may be dynamically updated in response to partial or modified user input provided to the interface 300b. The partial input may be a partial description, which may include one or more complete sentences or, in some cases, may be a portion of a sentence. This provides immediate visual feedback to the user about which options are recommended or available for the currently described issue or problem. This may prompt the user to modify or supplement the description in order to influence the recommended process flow. In these types of implementations, subsequent to receiving a first portion of the natural language input and performing an initial analysis and graphical output, the system may receive a second portion of the natural language input, compute a second set of confidence scores (or other intent signals) and produce another different graphical output that accounts for the additional natural language input. A similar subsequent analysis and output may be produced in response to an edited or modified user input. The analysis interval may be performed on a given time interval and/or threshold amount of additional or modified user input provided to the interface. In this way, different graphical objects may be visually emphasized, displayed, or suppressed from display in response to modifications or additions to the user input.

FIG. 3C depicts an example interface 300c in which graphical objects have been suppressed from display. Specifically, the graphical objects associated with synchronous process flows and user-directed process flows (e.g., objects 340a and 360a of FIG. 3A) have been suppressed and the graphical object 340c associated with an asynchronous process flow is displayed. The interface 300c may be generated in accordance with or in response to a determination that the set of confidence scores (or other intent signal) satisfies an asynchronous criteria. As discussed previously, the asynchronous criteria may be satisfied when a first confidence score associated with an asynchronous process flow or intent exceeds a second confidence score associated with a synchronous process flow or intent by at least a threshold amount. As also discussed previously, other techniques for evaluating an asynchronous criteria may be used.

While selectable graphical objects in FIG. 3C are suppressed from display (e.g., objects 340a and 360a of FIG. 3A), one or more of the objects may be replaced with a text-based link (also referred to as a “text link” or simply a “link). Replacing the object with a link does not require that the text be positioned in the identical location on the interface or that a direct replacement occur. For example, in the example interface 300c, the text-based link 350c is generated in line with content not previously displayed in the original interface. Selection of either the original graphical object (350a of FIG. 3A) or the text-based link 350c may redirect the user to the same corresponding platform and/or corresponding interface. In this way, while the interface 300c may bias the user toward a particular process flow, the user can still elect to pursue another process flow or platform. In some cases, the link may take the form of a smaller icon, button, or other object that is visually distinguishable from the original object or the remaining, unsuppressed objects.

As shown in FIG. 3C, the interface 300c also includes a set of graphical objects 361-364 that correspond to content items selected by the system to address the user query or input. The graphical objects 361-364 may be displayed in response to a user selection of a graphical object (e.g., 360a of FIG. 3A) associated with a user-directed process flow. In some implementations, the graphical objects 361-364 are displayed in response to the set of confidence intervals satisfying a user-directed criteria also referred to as knowledge intent criteria, or self-help criteria. This criteria may be satisfied if the respective confidence score exceeds a threshold value without a comparison to other confidence values. This allows the display of potentially useful content without regard to a particular process flow (synchronous or asynchronous) being currently recommended. Factors that may affect the respective confidence score for the user-directed criteria may be the number of times a similar query has been submitted and an amount of correlation with existing documentation.

In response to the set of confidence scores satisfying a user-directed criteria or knowledge intent criteria, a search of a knowledge base or content store of content items may be performed using one or more tokens or keywords extracted from the natural language input. The search of the knowledge base or other content store may be used to obtain a set of content item results. An elastic search or other search technique may be used to identify candidate content items, which may be ranked in accordance with a similarity analysis between the user input and the respective content items, a quality or use ranking of the respective content items, and other potential factors. In one example, the set of content items is ranked based on a prior usage criteria, which may include the number of times that the article was predicted to be useful in resolving an issue. In some cases, content items that are attached to or associated with a respective ticket or issue for a similar problem may also be ranked higher with respect to other content items. A subset of content items of the set of candidate content items may be selected using the ranking. Some or all of the graphical objects 361-364 may correspond to top-ranking results.

As shown in FIG. 3C, the graphical objects 361-364 can link to different content items on different platforms. Graphical objects 361-362 may be selectable to cause redirected to a respective knowledge base article on a knowledge base platform, graphical object 363 may redirect to a product documentation or collaboration platform, and graphical object 364 may redirect to a previously resolved ticket of an issue tracking platform. In some cases, a preview or snippet of content extracted from the respective content items is also displayed in the interface 300c.

FIG. 3D depicts an intake portal graphical user interface 300d that includes generative content that may be generated in response to an analysis of user input. Specifically, the interface 300d depicts suggested queries or follow up questions in response to the intent analysis model indicating that the natural language input may be ambiguous or lack sufficient detail to recommend a process flow in accordance with the examples described above with respect to FIGS. 2 and 3A-3C. The example of FIG. 3D may be implemented using the intent analysis model in order to both solicit more information or a reformulated query from the user and, when the query contains sufficient detail or indent, modify the interface 300d to indicate which platform is recommended for a respective process flow.

As shown in FIG. 3D, the interface 300d includes an input field 312 and a set of graphical objects 340d, 350d, 360d similar to the previous examples. Also similar to previous examples, the user input, including the natural language user input and other selections and entries, can be provided for processing by the intent analysis model to obtain a set of intent signals (e.g., set of confidence scores). In this example, in response to the intent signals satisfying an ambiguity criteria, the system may leverage a generative output engine in order to provide a content suggestion interface 370 having one or more suggested phrases 372 that can be adopted or modified by the user for submission to the system for further analysis. As discussed previously, the ambiguity criteria may be satisfied if the set of intent signals is too weak, as indicated by a set of values that are below an ambiguity or signal threshold. The criteria may also be satisfied if the analysis model fails to produce an output that meets a utility criteria or other indication that the output of the model is not satisfactory or reliable. In some cases, the ambiguity criteria may also rely on a token or word count and/or a semantic analysis of the natural language user input, which may be used to indicate incomplete sentences, ambiguous or poorly phrased strings, and/or nonsensical entries.

A more detailed description of the use of a generative output engine is provided below with respect to FIGS. 9-11B. As applied to the current example, in response to a set of confidence scores (or other intent signals) satisfying the ambiguity criteria, the system may generate a prompt that includes data extracted from the interface and other aspects of the system in order to produce a generative response that includes a list of suggested queries or suggested text. For example, the system may generate a prompt that includes a portion of the natural language user input and content extracted from one or more issues of the issue tracking platform. The issues may be identified using a search conducted using the natural language user input, prior user history or tenant history, prior session data, or other data associated with the current user or associated tenant. The issues may correspond to previous issues resolved with respect to the particular tenant/user and may include content including, an issue description, message exchanges, resolution descriptions, knowledge base articles, and other content that may provide context for the prompt. In particular, text extracted from an initial set of messages associated with an identified issue along with an issue description may be extracted and used to generate the prompt. In some cases, content may be extracted from other user input including text or values provided to the various fields and/or content extracted from the files uploaded via the interface 300d. The prompt may also include predetermined query prompt text, which may include instructions requesting suggested query text, example input-output pairs, preferred phrasing, character constraints, and other predetermined instructions for provoking useful or more detailed suggested queries or text.

Similar to as described below with respect to FIGS. 9-11B, the prompt may be provided to a generative output engine. The generative output engine may be accessed as an external service and the prompt may be transmitted to the generative output engine using an application programming interface call or other similar platform-to-platform communication technique. In some implementations, the generative output engine is integrated with the system and the prompt may be provided by saving the data to a designated location or by calling the generative output engine using an internal service or function call. In response to being provided the prompt, the generative output engine may produce a generative response that includes text responsive to the prompt. In response to receiving the generative response, the system may generate the content of the suggesting interface 370, which includes one or more suggested phrases 372 that include content extracted from the generative response.

Each of the one or more suggested phrases 372 may be individually selectable via the interface 370. The one or more suggested phrases 372 may be selected by the user, which may cause the corresponding phrase(s) to be displayed in the user input field 312 and may either be adopted, in whole, by the user or modified or edited for submission as a subsequent or modified query. In some cases, selection of the one or more suggested phrases 372 replaces the original user-provided text in the user input field 312. In other cases, the one or more suggested phrases 372 supplement or are appended to the original user-provided text. In some implementations, the one or more suggested phrases 372 are provided directly to the user input field 312 and the separate interface 370 is not utilized. Once adopted or modified by the user, the system may analyze the content of the user input field 312 along with other user input provided to the interface 300d using the intent analysis model to modify the graphical objects or other aspects of the interface 300d, as described with respect to other examples provided herein.

As described above with respect to many example embodiments, an intake portal graphical user interface may be generated and modified in accordance with an analysis of the user input including a natural language input. The modified or generated interface may include one or more graphical objects that are selectable to cause redirection to a respective platform or interface associated with a respective process flow. FIGS. 4, 5A-5B, 7 and 8, described below, provide example interfaces which may be displayed in response to user activity with respect to the intake portal graphical user interfaces described herein.

FIG. 4 depicts an example chat interface 400 of a chat platform, which may be displayed in response to a user selection of a respective graphical object of an intake portal graphical user interface. The chat interface 400 may be used to conduct what is referred to herein as a synchronous process flow. A synchronous process flow may include a process flow in which a user can electronically access an agent or services directly in order to obtain assistance with a particular problem or issue. While not required, a synchronous process flow may be conducted in a single session between the user and an agent or services through an exchange of real-time or near real-time message exchanges such that the participation of the agent and user is typically concurrent (not necessarily simultaneous or perfectly synchronized) and have at least some overlapping participation or interaction times. A synchronous process flow may be well adapted for certain classes of queries or issues including issues that require frequent or immediate feedback or data collection from the user, issues that may be dynamically evolving or transient in nature, or may provide the immediate attention that the user expects for an urgent or critical issue. Initiation of a synchronous process flow does not preclude other parallel processes, which may include asynchronous processes like issue or ticket creation and processing and user-directed processes like self-directed research or self-help. In fact, many queries may be resolved using what may be referred to as a hybrid process, which uses two or more process flows to process a query to resolution.

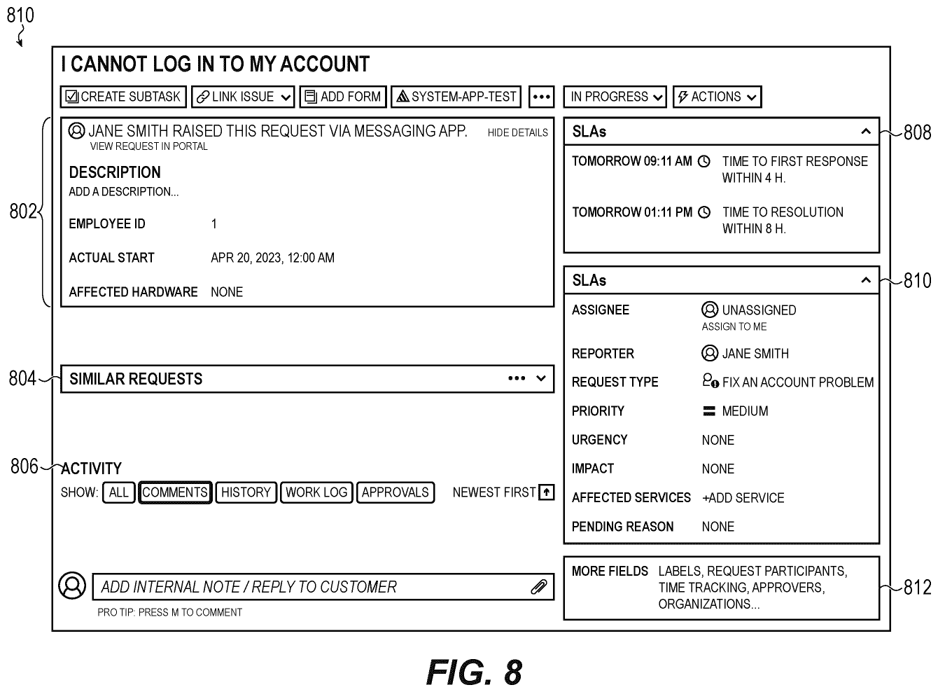

As shown in FIG. 4, the interface 400 includes a message region 420, which includes a series of messages generated as part of a messaging session or chat session. The interface 400 also includes a navigation region 410 that includes various selectable elements 412, including, for example, selectable elements corresponding to channels, chat session participants or contributors, system users, and other chat platform objects or entities. The chat interface 400 may also include links or embedded content obtained from separate platforms and displayed as a graphical object 424. In the present example, the graphical object 424 corresponds to a related issue managed by an issue tracking platform. The issue may have been generated in response to the user query submitted to the intake portal graphical user interface or otherwise related to the current problem being addressed by the system. In response to a user selection of the graphical object 424, the user may be directed to an issue graphical user interface, as described below with respect to FIGS. 5A-5B and 8. As described previously, this allows the user to navigate between platforms and engage a hybrid process flow that uses both synchronous and asynchronous process flows.

At least some of the content depicted in the interface 400 may be pre-populated or extracted from the intake portal or intake portal graphical user interface. For example, the message content 422, the chat channel title, participant information, and other content used by the chat platform to operate the chat interface 400 or other aspects of the platform may be extracted from the user input, analysis model output, a generative output engine, or another aspect or operation associated with the intake portal. In this way, user input of redundant information can be avoided and the user may be provided a more seamless or consistent experience across the platforms.

FIGS. 5A-5B depict an example issue interface 500a, 500b of an issue tracking platform, which may be displayed in response to a user selection of a respective graphical object of an intake portal graphical user interface. FIGS. 7A-7C and 8, described in more detail below, also illustrate example issue interfaces of an issue tracking platform, which may be displayed in response to user activity with respect to the intake portal interface. The issues interfaces 500a, 500b may be used to conduct what is referred to herein as an asynchronous process flow. An asynchronous process flow may include a process flow in which a user can initiate or generate an issue or ticket, that is processed in accordance with an issue workflow defined by the issue tracking platform. While not required, an asynchronous process flow may be conducted over multiple sessions involving the user and an agent or services that may occur at non-concurrent or non-overlapping times. An asynchronous process flow may be well adapted for certain classes of queries or issues including issues that require participation from users that may have limited availability or may be concurrently handling a large volume of issues that make direct and concurrent interaction difficult or impractical. An asynchronous process flow may also be well adapted for difficult problems that may not be resolved in real time including software bug fixes, feature improvements, or other technical issues that require a longer time frame for resolution. Asynchronous process flows may also be appropriate for non-critical issues in which a customer's needs can be met without providing immediate or concurrent resolution. As described previously, initiation of an asynchronous process flow does not preclude other parallel processes, which may include synchronous processes and user-directed processes.

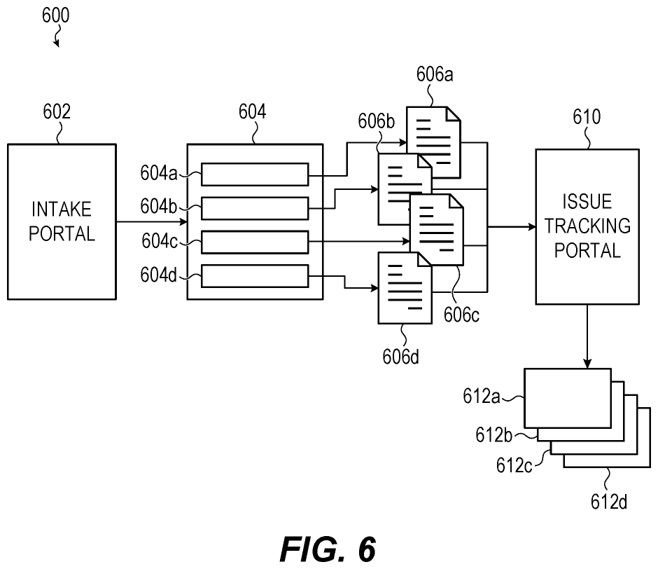

FIG. 5A depicts an example detail issue interface 500a of an issue or ticket object managed by an issue tracking platform. The issue interface 500a depicts example issue content or issue data that may be generated as part of an issue creation process described herein with respect to FIGS. 6-8. Specifically, the issue interface 500a may include a title 502, which may be based on a request type that is associated with the issue as part of generating the issue based on the issue creation process or as specified by the user. The issue data can also include an identification of a requesting user account 503, which may be used to access user data associated with the requesting user. The issue data can also include an issue description 504, which may be automatically generated based on the user input to the intake portal interface or may be generated by a system user. In the present example, the issue data can include linked issues 505, which may be related and/or otherwise be linked to the particular issue ticket. The issue data can include data related to similar requests 506, which may identify similar issues (resolved or pending) such as issues having similar subject matter. For example, the similar requests 506 may include issues that are identified as having similar subject matter using semantic analysis of the issue data associated with the issue ticket and other issues managed by the issue tracking system. The issue data can include object links 508, which may be identified by an agent, knowledgebase queries performed by the system, and/or using a generative output engine, as described herein.

The issue data can also include SLA information 510, which may define parameters for responding to the issue, performing actions related to the issue, resolving the issue, and so on. The issue data can also include issue details 512, which may include a priority level associated with the issue, request types, an indication of an agent assigned to the issue, and/or other information that may be relevant to responding to the issue. In some cases, the issue data can include an automation summary 514, which can include information about automations or other actions that have been performed by the system.

In some cases, the issue data can include an activity log 520, which can include information about all activity/actions that have been performed in relation to the issue. For example, the activity log 520 can include information related to transaction messages 522 (e.g., “comments” or other electronic message content), information related to automations, workflows, user interaction events, issue state transitions, and/or other events that occur over the lifecycle of the issue, which may be indexed and searchable by the system. As shown in FIG. 5A, the activity log 520 is selected and displays messages 522 that are associated with the issue. An issue can include internal messages, which are messages between agent users in relation to the issue, which may not be viewable to a user that submitted the issue. The issue can also include customer messages which may be messages between an agent (and/or automated messages generated by the system) and a user who submitted the issue. Both internal and external messages may be captured in transaction message data.

FIG. 5B depicts an example interface 500b that illustrates another view of the issue depicted in FIG. 8A. In the specific example interface 500b, the issue data includes activity log data 525 that is associated with the issue. For example, the activity log data 525 can include data related to a workflow of the issue. As discussed previously, the workflow may define a series of states that the issue or task must traverse before being completed. The activity data log data 525 may also track user interaction events, issue state transitions, and other events that occur over the lifecycle of the issue, which may be indexed and searchable by the system.

At least some of the content depicted in the interface 500 may be pre-populated or extracted from the intake portal or intake portal graphical user interface. For example, the issue title 502, issue description 504, and other content used by the issue tracking platform may be extracted from the user input, analysis model output, a generative output engine, or another aspect or operation associated with the intake portal. In this way, user input of redundant information can be avoided and the user may be provided a more seamless or consistent experience across the platforms.

Furthermore, some or all of the issue data may be available as training data for training the intent analysis model, described herein. Particularly, issue descriptions, message exchanges, resolutions, attached documents and other content may be extracted from previously completed issues and used to train an analysis model used to operate the intake portal, described herein. In the present example, content extracted from activity logs 520 and 525 may be used to characterize the issue and may be extracted for use as training data for the analysis model. Other data including, time to resolution, number of interactions, user feedback, and resolution description, may be used to characterize the issue and may be used as training data.

FIGS. 6-8, described below describe an example issue-creation process and corresponding interfaces which may be generated by an issue tracking platform. The process described with respect to FIGS. 6-8 may be initiated in response to a user interaction with an issue intake portal, as described herein. In some implementations, the issue-generation interfaces described with respect to FIGS. 7A-7C may be displayed in response to a user selection of a corresponding graphical object generated as part of the intake portal graphical user interface.

FIG. 6 shows an example process flow 600 for an example issue-creation flow using an intake portal or other similar issue reporting software interface. The example process flow 600 can be used to cause creation of an issue such as described with reference to FIGS. 5A-5B. Through the following examples, the selection and use of issue-creation forms are demonstrated as the operations relate to issues managed by an issue tracking platform. With regard to the other examples described herein, stored issues may be associated with a form identifier or form ID, also broadly referred to as an issue type or issue classifier, which can be used by the systems described herein to identify relevant issues, train an analysis model, and/or generate a form link as part of a generative service or generative interface.

With regard to FIG. 6, a user may use the process flow 600 to generate tickets or issues to assist with a problem or other task that needs to be addressed. Following authentication, a user (e.g., a service agent or a customer) may access the help desk portal 602 or other intake interface. The help desk portal 602 may be a separate portal or issue-creation interface than the intake interface portal described with respect to the previous examples. Specifically, the help desk portal 602 may remain available independent of the intake portal described previously in order to allow users to directly engage a synchronous process flow without accessing the intake portal graphical user interface described above with respect to FIGS. 3A-3D. Alternatively, the help desk portal may be operated in accordance with the operations of the intake portal graphical user interface, as previously described herein.

In the example process 600 of FIG. 6, the user is able to initially classify an issue by selecting one of a set of sub-portal options 704a, 704b, 704c, 704d. Each of the sub-portal options 704a, 704b, 704c, 704d is associated with a respective interface, also referred to as an issue-creation interface. Each form may include fields that are adapted for use with a particular classification or type of issue. In the present example, each sub-portal option or issue-creation interface may be generated in accordance with a respective issue form 706a, 706b, 706c, 706d. Completion of a respective interface presented in accordance with a respective sub-portal option 704a, 704b, 704c, 704d may cause creation of a respective issue, which may be provided to an issue tracking portal or backend system 1110, which is configured to process the corresponding issues 712a, 712b, 712c, 712d.

As shown in FIG. 7A, a home page of the help desk portal 702 may include an array of selectable cards or objects that correspond to a set of sub-portals. The array of selectable cards represents the various intake categories or classifications of issues that may be created using the system. Selecting an object associated with a particular intake category may cause the system to redirect the user interface to a respective issue-creation interface. For example, the help desk portal 702 may include a selection corresponding to an ITSM portal 702 where a user may seek IT-related assistance. Similarly, the help desk may include portals 704 for different departments of an enterprise, including human resources, finances, and so on. The help desk portal 702 may also include a search bar 706 to facilitate finding information, such as documents relating to a knowledge base.

Upon selecting a sub-portal, such as the ITSM portal 702, an interface for raising an issue is presented, as shown in FIG. 7B. The issue-creation interface of FIG. 7B may be displayed in response to a user selection of a respective object in the intake portal user interface described above with respect to FIGS. 3A-3D. In some cases, selection of the respective object in the intake portal user interface causes the interface to be redirected to the interface depicted in FIG. 7A, 7B, or, 7C. Also, as described previously, data may be extracted from the user input including the natural language user input, uploaded files, context or session data, user role or other user profile information, and other data associated with a session. The extracted data may be used to pre-populate forms of the issue-creation interface or may be used to partially route the user through the portals and sub-portal interfaces described with respect to this particular example.

As shown in FIG. 7B, the interface may include multiple input items that correspond to fields, such as a request type field 712, a requestor field 714, a summary field 716, and a description field 718. Upon selecting the request type field 712, the user may be presented with a menu of intake categories. As shown in FIGS. 7A and 7B, the menu of intake categories allows users to select a request that best fits their needs. For example, “FIX AN ACCOUNT PROBLEM,” “GET A GUEST WIFI ACCOUNT,” “GET IT HELP,” “NEW MOBILE DEVICE,” and “ONBOARD NEW EMPLOYEES” may each correspond to different requests. Each of these requests may correspond to intake interfaces 604a-d in FIG. 6.

Upon selection of an intake or issue-creation interface (e.g., 604a, 604b, 604c, or 604d), a backend application may retrieve a form template 606a, 606b, 606c, 606d that corresponds to the intake or issue-creation interface. Each of these forms may be created by an administrator via a request creator form interface 608 and may be identified or retrieved using a form identifier or form ID. In some embodiments, each form is unique to the intake interface and includes input items that correspond to field elements from the request item builder, and which is tailored to the user's issue category. An example form (e.g., 606a) is presented in FIG. 7C.

As shown in FIG. 7C, the form is tailored to relevant information relating to a “FIX AN ACCOUNT PROBLEM” issue. For example, the form may include a user field 720, a summary field 722, a description field 724, a department number field 726, an actual start 728, and an affected hardware field 730. As shown in the figure, certain fields may be required, such as the summary field 722, the user field 720, and the department number field 726. As explained above, each of these fields may be tailored to the particular problem.

Once a user (e.g., a customer user, a service agent) fills out and submits the form (e.g., via “SEND” button 732), the service management system may transmit the data to an issue tracking system, which generates an issue item based on the data from the form. As shown in FIG. 6, a service agent or other system user may have access to an issue tracking portal 610, which may be a graphical user interface of the issue tracking platform. At the issue tracking portal, a user may view the data input into the form from the help desk, view the status of the ticket, view/edit other information, and the like. An example issue tracking portal interface is presented in FIG. 8.

As shown in FIG. 8, the issue tracking portal 800 may display an issue item and relevant tracking information. For example, the data input in the form 606a may be displayed in a first display area 802. In some cases, users (e.g., agents, administrators) may edit these fields as more information is received. In some cases, the intake interfaces may include hidden fields. These hidden fields may be displayed to users in the first display area 802.

As discussed previously, the issue tracking platform may store or track the issue-creation form that was used to create respective issues or tickets. The issue-creation form that was used to create the issue may be stored as a form identifier or form ID and associated with the issue or ticket in the issue tracking platform. The issue tracking platform or the issue tracking portal may also gather other data (e.g., from user event logs or databases coupled to the issue tracking system), including similar requests 804 and activity 806. In many cases, enterprises use a service-level agreement (SLA), which specifies the process, timelines, and metrics by which services, such as IT, are provided. The issue tracking system may include issue item metric regions, such as regions 808 and 810, which may track metrics according to the SLA. For example, upon generating an issue item, the issue tracking system may automatically set a time for reply and completion that may correspond to the SLA. Similarly, region 810 may include editable field items that may be used to resolve the issue. For example, an issue item may be assigned to particular service agents, the urgency of the request may be set, and the like. The issue tracking portal 610 may also include other fields 812 which may be used by service agents to track metrics, add labels, track time, and the like.

The issue tracking platform may process each of the issues or tickets in accordance with a workflow or series of predefined states that the issue must traverse in order to be resolved by the issue tracking platform. An example workflow from the time an issue time is created is presented in FIG. 6. In some embodiments, at the intake interface builder interface, a workflow can be defined contemporaneously with the intake interface and with the issue item view in an issue tracking platform. When an issue is created 612, a workflow for resolving the issue is generated (e.g., via a backend application of the service management portal, such as the issue tracking system). As a first step, the issue may be assigned 614 to a service agent or other users. In some embodiments, the request type and/or other fields from the intake interface may determine the assigning step. For example, a group of users may be assigned to particular intake categories. As another example, a group of users may be assigned to a project where the particular request type can be used. As yet another example, a particular data input to a field (e.g., “AFFECTED HARDWARE”) may determine a user or a group of users to be assigned to the issue.

Once an issue item is assigned, the user or group of users assigned to the item may review 616 issue. On review of the issue, the assigned users may resolve 620 issue or may transfer 618 the issue, as an example. Upon transferring 618, updated assignees may review 616 issue again to ensure proper routing of the issue item. In some cases, the issue may be canceled 622 or it may be linked to another issue for a combined resolution. In some cases, depending on the complexity and/or the type of request, the workflow may include additional steps or less steps. More generally, the request type may dictate the number of steps and workflow used for each of the issue items. Accordingly, building an intake interface may determine the fields displayed in the help desk, the fields visible in the issue tracking system, and the workflow associated with the issue item.

As described above with respect to FIGS. 2 and 3D, a generative output engine may be used to provide generative content that is used to provide suggested queries or suggested text for an intake portal or other generative content. FIGS. 9-11B, described below, provide example systems and techniques for operating a generative service and obtaining generative content from a generative output engine.

### Scalable Network Architecture for Automatic Content Generation

Systems and methods described herein can leverage a scalable network architecture that includes an input request queue, a normalization (and/or redaction) preconditioning processing pipeline, an optional secondary request queue, and a set of one or more purpose-configured large language model instances (LLMs) and/or other trained classifiers or natural language processors.

Collectively, such engines or natural language processors may be referred to herein as “generative output engines.” A system incorporating a generative output engine can be referred to as a “generative output system” or a “generative output platform.” Broadly, the term “generative output engine” may be used to refer to any combination of computing resources that cooperate to instantiate an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof.

The string prompt (or “input prompt” or simply “prompt”) received as input by a generative output engine can be any suitably formatted string of characters, in any natural language or text encoding. In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt may include letters, numbers, whitespace, punctuation, and in some cases formatting. Similarly, the generative output of a generative output engine as described herein can be formatted/encoded according to any suitable encoding (e.g., ISO, Unicode, ASCII as examples). In these embodiments, a user may provide input to a software platform coupled to a network architecture as described herein. The user input may be in the form of interaction with a graphical user interface affordance (e.g., button or other UI element), or may be in the form of plain text. In some cases, the user input may be provided as typed string input provided to a command prompt triggered by a preceding user input.

For example, as described above, the system may invoke a generative service in response to an analysis of a user input provided to an intake portal. In another example, the user may engage with a button in a UI that causes a command prompt input box to be rendered, into which the user can begin typing a command. In other cases, the user may position a cursor within an editable text field and the user may type a character or trigger sequence of characters that cause a command-receptive user interface element to be rendered. As one example, a text editor may support slash commands-after the user types a slash character, any text input after the slash character can be considered as a command to instruct the underlying system to perform a task.

Regardless of how a software platform user interface is instrumented to receive user input, the user may provide an input that includes a string of text including a natural language request or instruction (e.g., a prompt). The prompt may be provided as input to an input queue including other requests from other users or other software platforms. Once the prompt is popped from the queue, it may be normalized and/or preconditioned by a preconditioning service.

The preconditioning service can, without limitation: append additional context to the user's raw input; may insert the user's raw input into a template prompt selected from a set of prompts; replace ambiguous references in the user's input with specific references (e.g., replace user-directed pronouns with user IDs, replace @mentions with user IDs, and so on); correct spelling or grammar; translate the user input to another language; or other operations. Thereafter, optionally, the modified/supplemented/hydrated user input can be provided as input to a secondary queue that meters and orders requests from one or more software platforms to a generative output system, such as described herein. The generative output system receives, as input, a modified prompt and provides a continuation of that prompt as output which can be directed to an appropriate recipient, such as the graphical user interface operated by the user that initiated the request or such as a separate platform. Many configurations and constructions are possible.

### Large Language Models

An example of a generative output engine of a generative output system as described herein may be a large language model (LLM). Generally, an LLM is a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine what word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phase referencing words, characters, numbers, whitespace, formatting, and the like), an LLM is trained against as large a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. Generally, an LLM may be trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist. For example, the grammatically incomplete prompt of “can a computer” invites completion, but also represents an initial phrase that can begin a near limitless number of probabilistically reasonable next words, phrases, punctuation and whitespace. A generative output engine may not provide a contextually interesting or useful response to such an input prompt, effectively choosing a continuation at random from a set of generated continuations of the grammatically incomplete prompt.

By contrast, a narrower prompt that invites continuation may be “can a computer supplied with a 30 W power supply consume 60 W of power?” A large number of possible correct phrasings of a continuation of this example prompt exist, but the number is significantly smaller than the preceding example, and a suitable continuation may be selected or generated using a number of techniques. In many cases, a continuation of an input prompt may be referred to more generally as “generated text” or “generated output” provided by a generative output engine as described herein.

Generally, many written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation. In addition, because punctuation and whitespace can serve as a portion of training data, the generated output of an LLM can be expected to be grammatically and syntactically correct, as well as being punctuated appropriately. As a result, generated output can take many suitable forms and styles, if appropriate in respect of an input prompt. Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt. For example, a prompt of “what is the syntax for a while loop in C and how does it work” may be continued by an LLM by providing, in addition to an explanation in natural language, a C++ compliant example of a while loop pattern. In some cases, the continuation/generative output may include format tags/keys such that when the output is rendered in a user interface, the example C++ code that forms a part of the response is presented with appropriate syntax highlighting and formatting.

As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

In yet further examples, an LLM generated output can convert static content to dynamic content. In one example, a user-generated document can include a string that contextually references another software platform. For example, a documentation platform document may include the string “this document corresponds to project ID 123456, status of which is pending.” In this example, a suitable LLM prompt may be provided that causes the LLM to determine an association between the documentation platform and a project management platform based on the reference to “project ID 123456.”

In response to this recognized context, the LLM can wrap the substring “project ID 123456” in anchor tags with an embedded URL in HTML-compliant syntax that links directly to project 123456 in the project management platform, such as: “<a href=′https://example link/123456>project 123456</a>”.

In addition, the LLM may be configured to replace the substring “pending” with a real-time updating token associated with an API call to the project management system. In this manner, the LLM converts a static string within the document management system into richer content that facilitates convenient and automatic cross-linking between software products, which may result in additional downstream positive effects on performance of indexing and search systems.

In further embodiments, the LLM may be configured to generate as a portion of the same generated output a body of an API call to the project management system that creates a link back or other association to the documentation platform. In this manner, the LLM facilitates bidirectional content enrichment by adding links to each software platform.

More generally, a continuation produced as output by an LLM can include not only text, source code, pseudocode, structured data, and/or cross-links to other platforms, but it also may be formatted in a manner that includes titles, emphasis, paragraph breaks, section breaks, code sections, quote sections, cross-links to external resources, inline images, graphics, table-backed graphics, and so on.

In yet further examples, static data may be generated and/or formatted in a particular manner in a generative output. For example, a valid generative output can include JSON-formatted data, XML-formatted data, HTML-formatted data, markdown table formatted data, comma-separated value data, tab-separated value data, or any other suitable data structuring defined by a data serialization format.

### Transformer Architecture

In many constructions, an LLM may be implemented with a transformer architecture. In other cases, traditional encoder/decoder models may be appropriate. In transformer topologies, a suitable self-attention or intra-attention mechanism may be used to inform both training and generative output. A number of different attention mechanisms, including self-attention mechanisms, may be suitable.

In sum, in response to an input prompt that at least contextually invites continuation, a transformer-architected LLM may provide probabilistic, generated, output informed by one or more self-attention signals. Even still, the LLM or a system coupled to an output thereof may be required to select one of many possible generated outputs/continuations.

In some cases, continuations may be misaligned in respect of conventional ethics. For example, a continuation of a prompt requesting information to build a weapon may be inappropriate. Similarly, a continuation of a prompt requesting to write code that exploits a vulnerability in software may be inappropriate. Similarly, a continuation requesting drafting of libelous content in respect of a real person may be inappropriate. In more innocuous cases, continuations of an LLM may adopt an inappropriate tone or may include offensive language.

In view of the foregoing, more generally, a trained LLM may provide output that continues an input prompt, but in some cases, that output may be inappropriate. To account for these and other limitations of source-agnostic trained LLMs, fine tuning may be performed to align output of the LLM with values and standards appropriate to a particular use case. In many cases, reinforcement training may be used. In particular, output of an untuned LLM can be provided to a human reviewer for evaluation.

The human reviewer can provide feedback to inform further training of the LLM, such as by filling out a brief survey indicating whether a particular generated output: suitably continues the input prompt; contains offensive language or tone; provides a continuation misaligned with typical human values; and so on.

This reinforcement training by human feedback can reinforce high quality, tone neutral, continuations provided by the LLM (e.g., positive feedback corresponds to positive reward) while simultaneously disincentivizing the LLM to produce offensive continuations (e.g., negative feedback corresponds to negative reward). In this manner, an LLM can be fine-tuned to preferentially produce desirable, inoffensive, generative output which, as noted above, can be in the form of natural language and/or source code.

### Generative Output Engines & Generative Output Systems

Independent of training and/or configuration of one or more underlying engines (typically instantiated as software), it may be appreciated that generally and broadly, a generative output system as described herein can include a physical processor or an allocation of the capacity thereof (shared with other processes, such as operating system processes and the like), a physical memory or an allocation thereof, and a network interface. The physical memory can include datastores, working memory portions, storage portions, and the like. Storage portions of the memory can include executable instructions that, when executed by the processor, cause the processor to (with assistance of working memory) instantiate an instance of a generative output application, also referred to herein as a generative output service.

The generative output application can be configured to expose one or more API endpoints, such as for configuration or for receiving input prompts. The generative output application can be further configured to provide generated text output to one or more subscribers or API clients. Many suitable interfaces can be configured to provide input to and receive output from a generative output application, as described herein.

For simplicity of description, the embodiments that follow reference generative output engines and generative output applications configured to exchange structured data with one or more clients, such as the input and output queues described above. The structured data can be formatted according to any suitable format, such as JSON or XML. The structured data can include attributes or key-value pairs that identify or correspond to subparts of a single response from the generative output engine.

For example, a request to the generative output engine from a client can include attribute fields such as, but not limited to: requester client ID; requester authentication tokens or other credentials; requester authorization tokens or other credentials; requester username; requester tenant ID or credentials; API key(s) for access to the generative output engine; request timestamp; generative output generation time; request prompt; string format form generated output; response types requested (e.g., paragraph, numeric, or the like); callback functions or addresses; generative engine ID; data fields; supplemental content; reference corpuses (e.g., additional training or contextual information/data) and so on. A simple example request may be JSON formatted, and may be:
{
   “prompt”: “Generate five words of placeholder text in the English language.”,
   “API_KEY: “hx-Y5u4zx3kaF67AzkXK1hC”,
   “user_token”: “PkcLe7Co2G-50AoIVojGJ”
}

Similarly, a response from the generative output engine can include attribute fields such as, but not limited to: requester client ID; requester authentication tokens or other credentials; requester authorization tokens or other credentials; requester username; requester role; request timestamp; generative output generation time; request prompt; generative output formatted as a string; and so on. For example, a simple response to the preceding request may be JSON formatted and may be:
{
   “response”: “Hello world text goes here.”,
   “generation_time_ms”: 2
}

In some embodiments, a prompt provided as input to a generative output engine can be engineered from user input. For example, in some cases, a user input can be inserted into an engineered template prompt that itself is stored in a database. For example, an engineered prompt template can include one or more fields into which user input portions thereof can be inserted. In some cases, an engineered prompt template can include contextual information that narrows the scope of the prompt, increasing the specificity thereof.

For example, some engineered prompt templates can include example input/output format cues or requests that define for a generative output engine, as described herein, how an input format is structured and/or how output should be provided by the generative output engine.

### Prompt Pre-Configuration, Templatizing, & Engineering

As noted above, a prompt received from a user can be preconditioned and/or parsed to extract certain content therefrom. The extracted content can be used to inform selection of a particular engineered prompt template from a database of engineered prompt templates. Once the selected prompt template is selected, the extracted content can be inserted into the template to generate a populated engineered prompt template that, in turn, can be provided as input to a generative output engine as described herein.

In many cases, a particular engineered prompt template can be selected based on a desired task for which output of the generative output engine may be useful to assist. For example, if a user requires a summary of a particular document, the user input prompt may be a text string comprising the phrase “generate a summary of this page.” A software instance configured for prompt preconditioning—which may be referred to as a “preconditioning software instance” or “prompt preconditioning software instance”—may perform one or more substitutions of terms or words in this input phrase, such as replacing the demonstrative pronoun phrase “this page” with an unambiguous unique page ID. In this example, preconditioning software instance can provide an output of “generate a summary of the page with id 123456” which in turn can be provided as input to a generative output engine.

In an extension of this example, the preconditioning software instance can be further configured to insert one or more additional contextual terms or phrases into the user input. In some cases, the inserted content can be inserted at a grammatically appropriate location within the input phrase or, in other cases, may be appended or prepended as separate sentences. For example, in an embodiment, the preconditioning software instance can insert a phrase that adds contextual information describing the user making the initial input and request. In this example, output of the prompt preconditioning instance may be “generate a summary of the page with id 123456 with phrasing and detail appropriate for the role of user 76543.” In this example, if the user requesting the summary is an engineer, a different summary may be provided than if the user requesting the summary is a manager or executive.

In yet other examples, prompt preconditioning may be further contextualized before a given prompt is provided as input to a generative output engine. Additional information that can be added to a prompt (sometimes referred to as “contextual information” or “prompt context” or “supplemental prompt information”) can include but may not be limited to: user names; user roles; user tenure (e.g., new users may benefit from more detailed summaries or other generative content than long-term users); user projects; user groups; user teams; user tasks; user reports; tasks, assignments, or projects of a user's reports, and so on.

For example, in some embodiments, a user-input prompt may be “generate a table of all my tasks for the next two weeks, and insert the table into my home page in my personal space.” In this example, a preconditioning instance can replace “my” with a reference to the user's ID or another unambiguous identifier associated with the user. Similarly, the “home page in my personal space” can be replaced, contextually, with a page identifier that corresponds to that user's personal space and the page that serves as the homepage thereof. Additionally, the preconditioning instance can replace the referenced time window in the raw input prompt based on the current date and based on a calculated date two weeks in the future. With these two modifications, the modified input prompt may be “generate a table of the tasks assigned to User 1234 dating from Jan. 1, 2023-Jan. 14, 2023 (inclusive), and insert the generated table into page 567.” In these embodiments, the preconditioning instance may be configured to access session information to determine the user ID.

In other cases, the preconditioning service may be configured to structure and submit a query to an active directory service or user graph service to determine user information and/or relationships to other users. For example, a prompt of “summarize the edits to this page made by my team since I last visited this page” could determine the user's ID, team members with close connections to that user based on a user graph, determine that the user last visited the page three weeks prior, and filter attribution of edits within the last three weeks to the current page ID based on those team members. With these modifications, the prompt provided to the generative output engine may be:
{
   “raw_prompt”: summarize the edits to this page made by my team since I last visited this page “,
   “modified_prompt”: “Generate a summary of each paragraph tagged with an editld attribute matching editId=1, editId=51, editId=165, editId=99 within the following HTML-formatted content: [HTML-formatted content of the page].”
}

Similarly, the preconditioning service may utilize a project graph, issue graph, or other data structure that is generated using edges or relationships between system objects that are determined based on express object dependencies, user event histories of interactions with related objects, or other system activity indicating relationships between system objects. The graphs may also associate system objects with particular users or user identifiers based on interaction logs or event histories.

Generally, a preconditioning service, as described herein, can be configured to access and append significant contextual information describing a user and/or users associated with the user submitting a particular request, the user's role in a particular organization, the user's technical expertise, the user's computing hardware (e.g., different response formats may be suitable and/or selectable based on user equipment), and so on.

In further implementations of this example, a snippet of prompt text can be selected from a snippet dictionary or table that further defines how the requested table should be formatted as output by the generative output engine. For example, a snippet selected from a database and appended to the modified prompt may be:
{
   “snippet123_table_from_tasks”: “The table should be formatted as a three-column table with multiple rows. The leftmost column should be titled ‘Title’ and the corresponding content of each row of this column should be the title attribute of a task. The middle column should be titled ‘Created Date’ and the corresponding content of each row of this column should be the creation date of the task. The rightmost column should be titled ‘Status’ and the corresponding content of each row of this column should be the status attribute of the selected task.”
}

The foregoing examples of modifications and supplements to user input prompt are not exhaustive. Other modifications are possible. In one embodiment, the user input of “generate a table of all my tasks for the next two weeks” may be converted, supplemented, modified, and/or otherwise preconditioned to:
{
   “modified_prompt”: “Find all tasks assigned to User 1234 dating from Jan. 1, 2023-Jan. 14, 2023 (inclusive). Create a table in which each found task corresponds to a respective row of that table. The table should be formatted as a markdown table, in plain text, with three columns. The leftmost column should be titled ‘Title’ and the corresponding content of each row of this column should be the title attribute of a respective task. The middle column should be titled ‘Created Date’ and the corresponding content of each row of this column should be the creation date of the respective task. The rightmost column should be titled ‘Status’ and the corresponding content of each row of this column should be the status attribute of the respective task.”
}

The operations of modifying a user input into a descriptive paragraph or set of paragraphs that further contextualize the input may be referred to as “prompt engineering.” In many embodiments, a preconditioning software instance may serve as a portion of a prompt engineering service configured to receive user input and to enrich, supplement, and/or otherwise hydrate a raw user input into a detailed prompt that may be provided as input to a generative output engine as described herein.

In other embodiments, a prompt engineering service may be configured to append bulk text to a prompt, such as document content in need of summarization or contextualization.

In other cases, a prompt engineering service can be configured to recursively and/or iteratively leverage output from a generative output engine in a chain of prompts and responses. For example, a prompt may call for a summary of all documents related to a particular project. In this case, a prompt engineering service may coordinate and/or orchestrate several requests to a generative output engine to summarize a first document, a second document, and a third document, and then generate an aggregate response of each of the three summarized documents. In yet other examples, staging of requests may be useful for other purposes.

### Authentication & Authorization

Still further embodiments reference systems and methods for maintaining compliance with permissions, authentication, and authorization within a software environment. For example, in some embodiments, a prompt engineering service can be configured to append to a prompt one or more contextualizing phrases that direct a generative output engine to draw insight from only a particular subset of content to which the requesting user has authorization to access.

In other cases, a prompt engineering service may be configured to proactively determine what data or database calls may be required by a particular user input. If data required to service the user's request is not authorized to be accessed by the user, that data and/or references to it may be restricted/redacted/removed from the prompt before the prompt is submitted as input to a generative output engine. The prompt engineering service may access a user profile of the respective user and identify content having access permissions that are consistent with a role, permissions profile, or other aspect of the user profile.

In other embodiments, a prompt engineering service may be configured to request that the generative output engine append citations (e.g., back links) to each page or source from which information in a generative response was based. In these examples, the prompt engineering service or another software instance can be configured to iterate through each link to determine (1) whether the link is valid, and (2) whether the requesting user has permission and authorization to view content at the link. If either test fails, the response from the generative output engine may be rejected and/or a new prompt may be generated specifically including an exclusion request such as “Exclude and ignore all content at XYZ.url.”

In yet other examples, a prompt engineering service may be configured to classify a user input into one of a number of classes of request. Different classes of request may be associated with different permissions handling techniques. For example, a class of request that requires a generative output engine to resource from multiple pages may have different authorization enforcement mechanisms or workflows than a class of request that requires a generative output engine to resource from only a single location.

These foregoing examples are not exhaustive. Many suitable techniques for managing permissions in a prompt engineering service and generative output engine system may be possible in view of the embodiments described herein.

More generally, as noted above, a generative output engine may be a portion of a larger network and communications architecture as described herein. This network can include input queues, prompt constructors, engine selection logical elements, request routing appliances, authentication handlers and so on.

### Collaboration Platforms Integrated with Generative Output Systems

In particular, embodiments described herein are focused on leveraging generative output engines to produce content in a software platform used for collaboration between multiple users, such as documentation tools, issue tracking systems, project management systems, information technology service management systems, ticketing systems, repository systems, telecommunications systems, messaging systems, and the like, each of which may define different environments in which content can be generated by users of those systems. These types of platforms may be generally referred to herein as “collaboration platforms” or “content collaboration platforms.”

In one example, a documentation system may define an environment in which users of the documentation system can leverage a user interface of a frontend of the system to generate documentation in respect of a project, product, process, or goal. For example, a software development team may use a documentation system to document features and functionality of the software product. In other cases, the development team may use the documentation system to capture meeting notes, track project goals, and outline internal best practices.

Other software platforms store, collect, and present different information in different ways. For example, an issue tracking system may be used to assign work within an organization and/or to track completion of work, a ticketing system may be used to track compliance with service level agreements, and so on. Any one of these software platforms or platform types can be communicably coupled to a generative output engine, as described herein, in order to automatically generate structured or unstructured content within environments defined by those systems.

In some implementations, a content collaboration system may include a documentation system, also referred to herein as a documentation platform, which can leverage a generative output engine to provide a generative answer interface to provide synthesized or generated responses leveraging content items hosted by the system. The documentation system may also leverage a generative output engine to provide, without limitation: summarize individual documents; summarize portions of documents; summarize multiple selected documents; generate document templates; generate document section templates; generate suggestions for cross-links to other documents or platforms; generate suggestions for adding detail or improving conciseness for particular document sections; and so on. As described with respect to examples provided herein, a documentation system can store user-generated content in electronic documents or electronic pages, also referred to herein simply as documents or pages. The documents or pages may include a variety of user-generated content including text, images, video and links to content provided by other platforms. The documentation system may also save user interaction events including user edit actions, content viewing actions, commenting, content sharing, and other user interactions. The document content in addition to select user interaction events may be indexed and searchable by the system. In some examples, the documentation system may organize documents or pages into a document space, which defines a hierarchical relationship between the pages and documents and also defines a permissions profile or scheme for the documents or pages of the space.

In some implementations, a content collaboration system may include an issue tracking system or task management system (also referred to herein as issue tracking platforms or issue management platforms). The issue tracking system may also leverage a generative output engine to provide a generative answer interface to provide synthesized or generated responses leveraging content items (e.g., issues or tasks) hosted by the system. The issue tracking system may also leverage a generative output engine to provide, without limitation: summarize issues; summarize portions of issues or fields of issues; summarize multiple selected issues, tasks, or events; generate issue templates; and so on. As described with respect to examples provided herein, an issue tracking system can manage various issues or tasks that are processed in accordance with an automated workflow. The workflow may define a series of states that the issue or task must traverse before being completed. The system may also track user interaction events, issue state transitions, and other events that occur over the lifecycle of the issue, which may be indexed and searchable by the system.

More broadly, it may be appreciated that a single organization may be a tenant of multiple software platforms, of different software platform types. Generally and broadly, regardless of configuration or purpose, a software platform that can serve as source information for operation of a generative output engine as described herein may include a frontend and a backend configured to communicably couple over a computing network (which may include the open Internet) to exchange computer-readable structured data.

The frontend may be a first instance of software executing on a client device, such as a desktop computer, laptop computer, tablet computer, or handheld computer (e.g., mobile phone). The backend may be a second instance of software executing over a processor allocation and memory allocation of a virtual or physical computer architecture. In many cases, although not required, the backend may support multiple tenancies. In such examples, a software platform may be referred to as a multi-tenant software platform.

For simplicity of description, the multi-tenant embodiments presented herein reference software platforms from the perspective of a single common tenant. For example, an organization may secure a tenancy of multiple discrete software platforms, providing access for one or more employees to each of the software platforms. Although other organizations may have also secured tenancies of the same software platforms which may instantiate one or more backends that serve multiple tenants, it is appreciated that data of each organization is siloed, encrypted, and inaccessible to, other tenants of the same platform.

In many embodiments, the frontend and backend of a software platform-multi-tenant or otherwise—as described herein are not collocated, and communicate over a large area and/or wide area network by leveraging one or more networking protocols, but this is not required of all implementations.

A frontend of a software platform, also referred to as a frontend or client application, may be configured to render a graphical user interface at a client device that instantiates frontend software. As a result of this architecture, the graphical user interface of the frontend can receive inputs from a user of the client device, which, in turn, can be formatted by the frontend into computer-readable structured data suitable for transmission to the backend for storage, transformation, and later retrieval. One example architecture includes a graphical user interface rendered in a browser executing on the client device. In other cases, a frontend may be a native application executing on a client device. Regardless of architecture, it may be appreciated that generally and broadly a frontend of a software platform as described herein is configured to render a graphical user interface to receive inputs from a user of the software platform and to provide outputs to the user of the software platform.

Input to a frontend of a software platform by a user of a client device within an organization may be referred to herein as “organization-owned” content. With respect to a particular software platform, such input may be referred to as “tenant-owned” or “platform-specific” content. In this manner, a single organization's owned content can include multiple buckets of platform-specific content.

Herein, the phrases “tenant-owned content” and “platform-specific content” may be used to refer to any and all content, data, metadata, or other information regardless of form or format that is authored, developed, created, or otherwise added by, edited by, or otherwise provided for the benefit of, a user or tenant of a multi-tenant software platform. In many embodiments, as noted above, tenant-owned content may be stored, transmitted, and/or formatted for display by a frontend of a software platform as structured data. In particular, structured data that includes tenant-owned content may be referred to herein as a “data object” or a “tenant-specific data object.”

In a more simple, non-limiting phrasing, any software platform described herein can be configured to store one or more data objects in any form or format unique to that platform. Any data object of any platform may include one or more attributes and/or properties or individual data items that, in turn, include tenant-owned content input by a user.

Example tenant-owned content can include personal data, private data, health information, personally-identifying information, business information, trade secret content, copyrighted content or information, restricted access information, research and development information, classified information, mutually-owned information (e.g., with a third party or government entity), or any other information, multi-media, or data. In many examples, although not required, tenant-owned content or, more generally, organization-owned content may include information that is classified in some manner, according to some procedure, protocol, or jurisdiction-specific regulation.

In particular, the embodiments and architectures described herein can be leveraged by a provider of multi-tenant software and, in particular, by a provider of suites of multi-tenant software platforms, each platform being configured for a different particular purpose. Herein, providers of systems or suites of multi-tenant software platforms are referred to as “multiplatform service providers.”

In general, customers/clients of a multiplatform service provider are typically tenants of multiple platforms provided by a given multiplatform service provider. For example, a single organization (a client of a multiplatform service provider) may be a tenant of a messaging platform and, separately, a tenant of a project management platform.

The organization can create and/or purchase user accounts for its employees so that each employee has access to both messaging and project management functionality. In some cases, the organization may limit seats in each tenancy of each platform so that only certain users have access to messaging functionality and only certain users have access to project management functionality; the organization can exercise discretion as to which users have access to either or both tenancies.

In another example, a multiplatform service provider can host a suite of collaboration tools. For example, a multiplatform service provider may host, for its clients, a multi-tenant issue tracking system, a multi-tenant code repository service, and a multi-tenant documentation service. In this example, an organization that is a customer/client of the service provider may be a tenant of each of the issue tracking system or platform, a code repository system or platform (also referred to as a source code management system or platform), and/or a documentation system or platform.

As with preceding examples, the organization can create and/or purchase user accounts for its employees, so that certain selected employees have access to one or more of issue tracking functionality, documentation functionality, and code repository functionality.

In this example and others, it may be possible to leverage multiple collaboration platforms to advance individual projects or goals. For example, for a single software development project, a software development team may use (1) a code repository to store project code, executables, and/or static assets, (2) a documentation platform to maintain documentation related to the software development project, (3) an issue tracking platform to track assignment and progression of work, and (4) a messaging service or platform to exchange information directly between team members. However, as organizations grow, as project teams become larger, and/or as software platforms mature and add features or adjust user interaction paradigms over time, using multiple software platforms can become inefficient for both individuals and organizations. Further, as described herein, it can be difficult to locate content or answer queries in a multiplatform system having diverse content and data structures used to provide the various content items. As described herein, a generative answer interface may be adapted to access multi-platform content and provide generative responses that bridge various content item types and platform structures.

These foregoing and other embodiments are discussed below with reference to FIGS. 9-11B. The detailed description given herein with respect to these figures is for explanation only and should not be construed as limiting.

### User Input Resulting in Generative Output

FIG. 9 depicts a simplified diagram of a system, such as described herein that can include and/or may receive input from a generative output engine as described herein. The system 900 is depicted as implemented in a client-server architecture, but it may be appreciated that this is merely one example and that other communications architectures are possible.

In particular, the system 900 includes a set of host servers 902 which may be one or more virtual or physical computing resources (collectively referred in many cases as a “cloud platform”). In some cases, the set of host servers 902 can be physically collocated or in other cases, each may be positioned in a geographically unique location. The set of host servers 902 can be communicably coupled to one or more client devices; two example devices are shown as the client device 904 and the client device 906. The client devices 904, 906 can be implemented as any suitable electronic device. In many embodiments, the client devices 904, 906 are personal computing devices such as desktop computers, laptop computers, or mobile phones.

The set of host servers 902 can be supporting infrastructure for one or more backend applications, each of which may be associated with a particular software platform, such as a documentation platform or an issue tracking platform. Other examples include ITSM systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system as well.

A user of the client devices may trigger production of generative output in a number of suitable ways. One example is shown in FIG. 9. In particular, in this embodiment, each of the software platforms can share a common feature, such as a common centralized editor rendered in a frame of the frontend user interfaces of both platforms.

Turning to FIG. 9, a portion of the set of host servers 902 can be allocated as physical infrastructure supporting a first platform backend 908 and a different portion of the set of host servers 902 can be allocated as physical infrastructure supporting a second platform backend 910. The two different platforms may be instantiated over physical resources provided by the set of host servers 902. Once instantiated, the first platform backend 908 and the second platform backend 910 can each communicably couple to a centralized content service 912. The centralized content service may be a generative content service, search interface, or, in some cases, a centralized editing service which may also referred to more simply as an “editor” or an “editor service.”

In implementations in which the centralized content service 912 is a search interface or generative content service, the service 912 may be instantiated or implemented in response to a user input provided to a frontend application in communication with one of the platform backends 908, 910. The service 912 may be configured to leverage authenticated user sessions between multiple platforms in order to access content and provide aggregated or composite results to the user. The service 912 may be instantiated as a plugin to the respective frontend application, may be integrated with the frontend application or, in some implementations, may be instantiated as a separate and distinct service or application instance.

In implementations in which this centralized content service 912 is an editing service, the centralized content service 912 may be referred to as a centralized content editing frame service 912. The centralized content editing frame service 912 can be configured to cause rendering of a frame within respective frontends of each of the first platform backend 908 and the second platform backend 910. In this manner, and as a result of this construction, each of the first platform and the second platform present a consistent user content editing experience.

More specifically, the centralized content editing frame service 912 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized content service 912 that can be called by each respective frontend whenever it is required to present the user of that respective frontend with an interface to edit text.

For example, the documentation platform's frontend may call upon the centralized content service 912 to render, or assist with rendering, a user input interface element to receive user text input in a generative interface of a documentation platform. Similarly, the issue tracking platform's frontend may call upon the centralized content service 912 to render, or assist with rendering, a user input interface element to receive user text input or other input in a generative interface. In these examples, the centralized content service 912 can parse text input provided by users of the documentation platform frontend and/or the issue tracking platform backend, monitoring for command and control keywords, phrases, trigger characters, and so on. In many cases, for example, the centralized content service 912 can implement a slash command service that can be used by a user of either platform frontend to issue commands to the backend of the other system. As described herein, the centralized content service 912 may cause display of a generative answer interface having input regions and controls that can be used to receive user input and provide commands to the system.

In one example, an intake portal or related aspect of the system may involve the centralized content service 912 in response to an analysis of a user input indicating that the input is ambiguous or lacks sufficient detail and, as such, suggested text or suggested queries may be helpful. In another example, the user of the documentation platform frontend can input a slash command to the content editing frame, rendered in the documentation platform frontend supported by the centralized content service 912, in order to type a prompt including an instruction to create a new issue or a set of new issues in the issue tracking platform. Similarly, the user of the issue tracking platform can leverage slash command syntax, enabled by the centralized content service 912, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized content service 912 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized content service 912 can be extended to include additional features and functionality-such as a user input field, selectable control, a slash command processor, or other user interface element-which, in turn, can automatically be leveraged by any further platform that incorporates a generative interface, and/or otherwise integrates with the centralized content service 912 itself. In this example, commands or input facilitated by the generative service can be used to receive prompt instructions from users of either frontend. These prompts can be provided as input to a prompt engineering/prompt preconditioning service (such as the prompt management service 914) that, in turn, provides a modified user prompt as input to a generative engine service 916.

The generative output engine service may be hosted over the host servers 902 or, in other cases, may be a software instance instantiated over separate hardware. In some cases, the generative engine service may be a third-party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on.

In addition, a centralized content service 912 can be configured to provide suggested prompts to a user as the user types. For example, as a user begins typing a slash command in a frontend of some platform that has integrated with a centralized content service 912 as described herein, the centralized content service 912 can monitor the user's typing to provide one or more suggestions of prompts, commands, or controls (herein, simply “preconfigured prompts”) that may be useful to the particular user providing the text input. The suggested preconfigured prompts may be retrieved from a database 918. In some cases, each of the preconfigured prompts can include fields that can be replaced with user-specific content, whether generated in respect of the user's input or generated in respect of the user's identity and session.

In some embodiments, the centralized content service 912 can be configured to suggest one or more prompts that can be provided as input to a generative output engine as described herein to perform a useful task, such as summarizing content rendered within the centralized content service 912, reformatting content rendered within the centralized content service 912, inserting cross-links within the centralized content service 912, and so on.

The ordering of the suggestion list and/or the content of the suggestion list may vary from user to user, user role to user role, and embodiment to embodiment. For example, when interacting with a documentation system, a user having a role of “developer” may be presented with prompts, content, or functionality associated with tasks related to an issue tracking system and/or a code repository system. Alternatively, when interacting with the same documentation system, a user having a role of “human resources professional” may be presented with prompts, content, or functionality associated with manipulating or summarizing information presented in a directory system or a benefits system, instead of the issue tracking system or the code repository system.

More generally, in some embodiments described herein, a centralized content service 912 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized content service 912 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein reference systems and methods for sharing user interface elements rendered by a centralized content service 912 and features thereof (such as input fields or a slash command processor), between different software platforms in an authenticated and secure manner. For simplicity of description, the embodiments that follow reference a configuration in which a centralized content editing frame service is configured to implement user input fields, selectable controls, a slash command processor, or other user interface elements.

More specifically, the first platform backend 908 can be configured to communicably couple to a first platform frontend instantiated by cooperation of a memory and a processor of the client device 904. Once instantiated, the first platform frontend can be configured to leverage a display of the client device 904 to render a graphical user interface so as to present information to a user of the client device 904 and to collect information from a user of the client device 904. Collectively, the processor, memory, and display of the client device 904 are identified in FIG. 9 as the client devices resources 904a-904c, respectively.

As with many embodiments described herein, the first platform frontend can be configured to communicate with the first platform backend 908 and/or the centralized content service 912. Information can be transacted by and between the frontend, the first platform backend 908 and the centralized content service 912 in any suitable manner, form, or format. In many embodiments, as noted above, the client device 904 and in particular the first platform frontend can be configured to send an authentication token 920 along with each request transmitted to any of the first platform backend 908 or the centralized content service 912 or the preconditioning service or the generative output engine.

Similarly, the second platform backend 910 can be configured to communicably couple to a second platform frontend instantiated by cooperation of a memory and a processor of the client device 906. Once instantiated, the second platform frontend can be configured to leverage a display of the client device 906 to render a graphical user interface so as to present information to a user of the client device 906 and to collect information from a user of the client device 906. Collectively, the processor, memory, and display of the client device 906 are identified in FIG. 9 as the client devices resources 609a-906c, respectively.

As with many embodiments described herein, the second platform frontend can be configured to communicate with the second platform backend 910 and/or the centralized content service 912. Information can be transacted by and between the frontend, the second platform backend 910 and the centralized content service 912 in any suitable manner, form, or format. In many embodiments, as noted above, the client device 906 and in particular the second platform frontend can be configured to send an authentication token 922 along with each request transmitted to any of the second platform backend 910 or the centralized content editing frame service 912.

As a result of these constructions, the centralized content service 912 can provide uniform feature sets to users of either the client device 904 or the client device 906. For example, the centralized content service 912 can implement a user input field, selectable controls, a slash command processor, or other user interface element to receive prompt input and/or preconfigured prompt selection provided by a user of the client device 904 to the first platform and/or to receive input provided by a different user of the client device 906 to the second platform.

As noted above, the centralized content service 912 ensures that common features, such as user input interpretation, slash command handling, or other input techniques are available to frontends of different platforms. One such class of features provided by the centralized content service 912 invokes output of a generative output engine of a service such as the generative engine service 916.

For example, as noted above, the generative engine service 916 can be used to generate content, supplement content, and/or generate API requests or API request bodies that cause one or both of the first platform backend 908 or the second platform backend 910 to perform a task. In some cases, an API request generated at least in part by the generative engine service 916 can be directed to another system not depicted in FIG. 9. For example, the API request can be directed to a third-party service (e.g., referencing a callback, as one example, to either backend platform) or an integration software instance. The integration may facilitate data exchange between the second platform backend 910 and the first platform backend 908 or may be configured for another purpose.

As with other embodiments described herein, the prompt management service 914 can be configured to receive user input (provided via a graphical user interface of the client device 904 or the client device 906) from the centralized content service 912. The user input may include a prompt to be continued by the generative engine service 916.

The prompt management service 914 can be configured to modify the user input, supplement the user input, select a prompt from a database (e.g., the database 918) based on the user input, insert the user input into a template prompt, replace words within the user input, perform searches of databases (such as user graphs, team graphs, and so on) of either the first platform backend 908 or the second platform backend 910, change grammar or spelling of the user input, change a language of the user input, and so on. The prompt management service 914 may also be referred to herein as an “editor assistant service” or a “prompt constructor.” In some cases, the prompt management service 914 is also referred to as a “content creation and modification service.”

Output of the prompt management service 914 can be referred to as a modified prompt or a preconditioned prompt. This modified prompt can be provided to the generative engine service 916 as an input. More particularly, the prompt management service 914 is configured to structure an API request to the generative engine service 916. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative engine service 916 should process the request; an output format or encryption identifier; and so on. One example of such an API request is a POST request to a Restful API endpoint served by the generative engine service 916. In other cases, the prompt management service 914 may transmit data and/or communicate data to the generative engine service 916 in another manner (e.g., referencing a text file at a shared file location, the text file including a prompt, referencing a prompt identifier, referencing a callback that can serve a prompt to the generative engine service 916, initiating a stream comprising a prompt, referencing an index in a queue including multiple prompts, and so on; many configurations are possible).

In response to receiving a modified prompt as input, the generative engine service 916 can execute an instance of a generative output engine, such as an LLM. As noted above, in some cases, the prompt management service 914 can be configured to specify what engine, engine version, language, language model or other data should be used to continue a particular modified prompt.

The selected LLM or other generative engine continues the input prompt and returns that continuation to the caller, which in many cases may be the prompt management service 914. In other cases, output of the generative engine service 916 can be provided to the centralized content service 912 to return to a suitable backend application, to in turn return to or perform a task for the benefit of a client device such as the client device 904 or the client device 906. More particularly, it may be appreciated that although FIG. 9 is illustrated with only the prompt management service 914 communicably coupled to the generative engine service 916, this is merely one example and that in other cases the generative engine service 916 can be communicably coupled to any of the client device 906, the client device 904, the first platform backend 908, the second platform backend 910, the centralized content service 912, or the prompt management service 914.

In some cases, output of the generative engine service 916 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative engine service 916 to the frontend (e.g., rendered on the client device 904, as one example) so that a user of the client device 904 can approve the content before it is prepended to the document. In another example, output of the generative engine service 916 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative engine service 916 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 9 relate to systems for collecting user input, modifying that user input into a particularly engineered prompt, and submitting that prompt as input to a trained large language model. Output of the LLM can be used in a number of suitable ways.

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative engine service 916.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to $ {user} with a due date in the next 2 days.” In this example, the token/field/variable $ {user} can be replaced with a user identifier corresponding to the user currently operating a client device.

This insertion of an unambiguous user identifier can be performed by the client device, the platform backend, the centralized content editing frame service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon” can be rendered for a user in a UI as described herein. Upon interaction with the button by the user, the prompt string “summarize all tasks assigned to user 123 with a due date in the next 2 days” can be retrieved from a database or other memory, and provided as input to the generative engine service 916.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “$ {user prompt}. Provide output of any table in the form of a tab delimited table formatted according to the markdown specification.” In this example, the variable $ {user prompt} may be replaced with the user prompt such that the entire prompt received by the generative engine service 916 can include the user prompt and the example sentence describing how a table should be formatted.

In yet other embodiments, a suggestion may be generated by the generative engine service 916. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative engine service 916 may generate a set of JSON objects that, when received by the Kanban platform, are rendered as a set of cards in a Kanban board, each card including a different title and description corresponding to different tasks that may be associated with steps for creating a new iced cream flavor. In this manner, the user can quickly be presented with an example set of initial tasks for a new project.

In yet other examples, suggestions can be configured to select or modify prompts that cause the generative engine service 916 to interact with multiple systems. For example, a suggestion in a documentation system may be to create a new document content section that summarizes a history of agent interactions in an ITSM system. In some cases, the generative engine service 916 can be called more than once and/or it may be configured to generate its own follow-up prompts or prompt templates which can be populated with appropriate information and re-submitted to the generative engine service 916 to obtain further generative output. More simply, in some embodiments, generative output may be recursive, iterative, or otherwise multi-step in some embodiments.

These foregoing embodiments depicted in FIG. 9 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 908 may be instantiated by cooperation of a processor and memory collectively represented in the figure as the resource allocations 908a.

Similarly, the second platform backend 910 may be instantiated over the resource allocations 910a (including processors, memory, storage, network communications systems, and so on). Likewise, the centralized content service 912 is supported by a processor and memory and network connection (and/or database connections) collectively represented for simplicity as the resource allocations 912a.

The prompt management service 914 can be supported by its own resources including processors, memory, network connections, displays (optionally), and the like represented in the figure as the resource allocations 914a.

In many cases, the generative engine service 916 may be an external system, instantiated over external and/or third-party hardware which may include processors, network connections, memory, databases, and the like. In some embodiments, the generative engine service 916 may be instantiated over physical hardware associated with the host servers 902. Regardless of the physical location at which (and/or the physical hardware over which) the generative engine service 916 is instantiated, the underlying physical hardware including processors, memory, storage, network connections, and the like are represented in the figure as the resource allocations 916a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organization's datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 914 may include a phrase directing an LLM to never return particular data, or to only return data from particular sources, and the like.

In some embodiments, the system 900 can include a prompt context analysis instance configured to determine whether a user issuing a request has permission to access the resources required to service that request. For example, a prompt from a user may be “Generate a text summary in Document 123 of all changes to Kanban board 456 that do not have a corresponding issue tagged in the issue tracking system.” In respect of this example, the prompt context analysis instance may determine whether the requesting user has permission to access Document123, whether the requesting user has written permission to modify Document 123, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative engine service 916.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

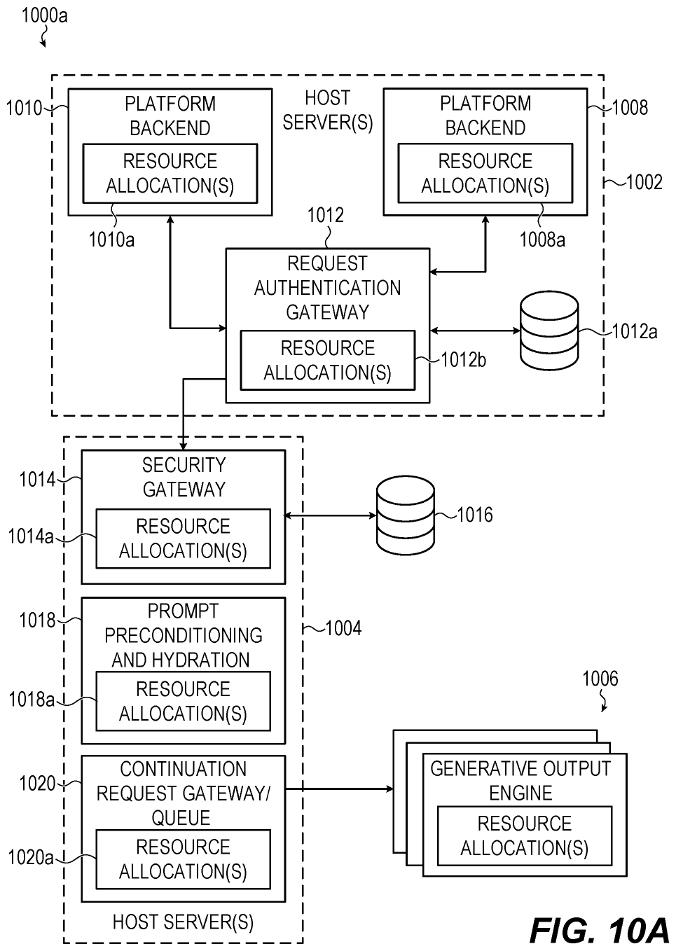

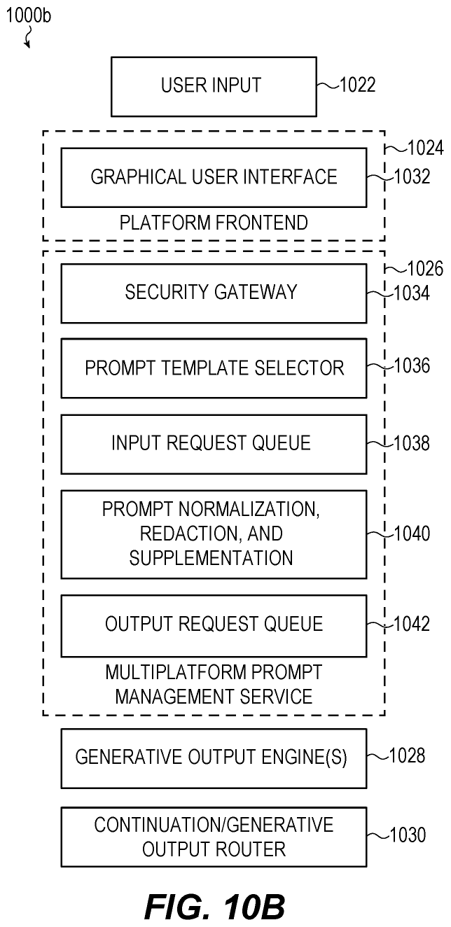

FIGS. 10A-10B depict system diagrams and network/communication architectures that may support a system as described herein. Referring to FIG. 10A, the system 1000a includes a first set of host servers 1002 associated with one or more software platform backends. These software platform backends can be communicably coupled to a second set of host servers 1004 purpose configured to process requests and responses to and from one or more generative output engines 1006.

Specifically, the first set of host servers 1002 (which, as described above can include processors, memory, storage, network communications, and any other suitable physical hardware cooperating to instantiate software) can allocate certain resources to instantiate a first and second platform backend, such as a first platform backend 1008 and a second platform backend 1010. Each of these respective backends can be instantiated by cooperation of processing and memory resources associated to each respective backend. As illustrated, such dedicated resources are identified as the resource allocations 1008a and the resource allocations 1010a.

Each of these platform backends can be communicably coupled to an authentication gateway 1012 configured to verify, by querying a permissions table, directory service, or other authentication system (represented by the database 1012a) whether a particular request for generative output from a particular user is authorized. Specifically, the second platform backend 1010 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 1012 can deny the request for insufficient permissions. This example is merely one and is not intended to be limiting; many possible authorization and authentication operations can be performed by the authentication gateway 1012. The authentication gateway 1012 may be supported by physical hardware resources, such as a processor and memory, represented by the resource allocations 1012b.

Once the authentication gateway 1012 determines that a request from a user of either platform is authorized to access data or resources implicated in service that request, the request may be passed to a security gateway 1014, which may be a software instance supported by physical hardware identified in FIG. 10A as the resource allocations 1014a. The security gateway 1014 may be configured to determine whether the request itself conforms to one or more policies or rules (data and/or executable representations of which may be stored in a database 1016) established by the organization. For example, the organization may prohibit executing prompts for offensive content, value-incompatible content, personally identifying information, health information, trade secret information, unreleased product information, secret project information, and the like. In other cases, a request may be denied by the security gateway 1014 if the prompt requests beyond a threshold quantity of data.

Once a particular user-initiated prompt has been sufficiently authorized and cleared against organization-specific generative output rules, the request/prompt can be passed to a preconditioning and hydration service 1018 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 1018 can be a software instance supported by physical hardware represented by the resource allocations 1018a. In some implementations, the hydration service 1018 may also be used to rehydrate personally identifiable information (PII) or other potentially sensitive data that has been extracted from a request or data exchange in the system.

Once a prompt has been modified, replaced, or hydrated by the preconditioning and hydration service 1018, it may be passed to an output gateway 1020 (also referred to as a continuation gateway or an output queue). The output gateway 1020 may be responsible for enqueuing and/or ordering different requests from different users or different software platforms based on priority, time order, or other metrics. The output gateway 1020 can also serve to meter requests to the generative output engines 1006.

FIG. 10B depicts a functional system diagram of the system 1000a depicted in FIG. 10A. In particular, the system 1000b is configured to operate as a multiplatform prompt management service supporting and ordering requests from multiple users across multiple platforms. In particular, a user input 1022 may be received at a platform frontend 1024. The platform frontend 1024 passes the input to a prompt management service 1026 that formalizes a prompt suitable for input to a generative output engine 1028, which in turn can provide its output to an output router 1030 that may direct generative output to a suitable destination. For example, the output router 1030 may execute API requests generated by the generative output engine 1028, may submit text responses back to the platform frontend 1024, may wrap a text output of the generative output engine 1028 in an API request to update a backend of the platform associated with the platform frontend 1024, or may perform other operations.

Specifically, the user input 1022 (which may be an engagement with a button, typed text input, spoken input, chat box input, and the like) can be provided to a graphical user interface 1032 of the platform frontend 1024. The graphical user interface 1032 can be communicably coupled to a security gateway 1034 of the prompt management service 1026 that may be configured to determine whether the user input 1022 is authorized to execute and/or complies with organization-specific rules.

The security gateway 1034 may provide output to a prompt selector 1036 which can be configured to select a prompt template from a database of preconfigured prompts, templatized prompts, or engineered templatized prompts. Once the raw user input is transformed into a string prompt, the prompt may be provided as input to a request queue 1038 that orders different user request for input from the generative output engine 1028. Output of the request queue 1038 can be provided as input to a prompt hydrator 1040 configured to populate template fields, add context identifiers, supplement the prompt, and perform other normalization operations described herein. In other cases, the prompt hydrator 1040 can be configured to segment a single prompt into multiple discrete requests, which may be interdependent or may be independent.

Thereafter, the modified prompt(s) can be provided as input to an output queue at 1042 that may serve to meter inputs provided to the generative output engine 1028.

These foregoing embodiments depicted in FIGS. 10A-10B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

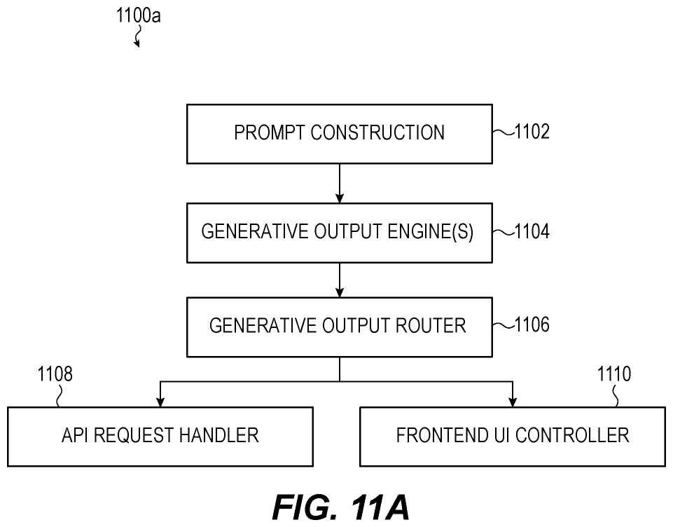

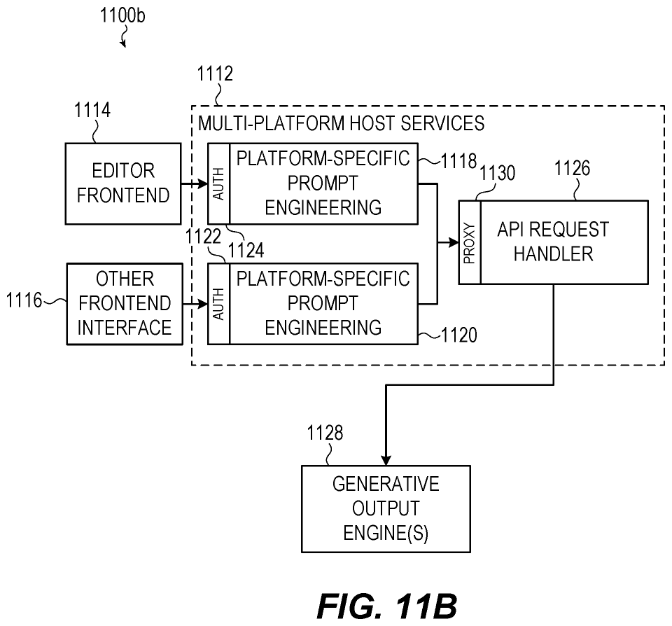

For example, although many constructions are possible, FIG. 11A depicts a simplified system diagram and data processing pipeline as described herein. The system 1100a receives user input and constructs a prompt therefrom at operation 1102. After constructing a suitable prompt, and populating template fields, selecting appropriate instructions and examples for an LLM to continue, the modified constructed prompt is provided as input to a generative output engine 1104. A continuation from the generative output engine 1104 is provided as input to a router 1106 configured to classify the output of the generative output engine 1104 as being directed to one or more destinations. For example, the router 1106 may determine that a particular generative output is an API request that should be executed against a particular API (e.g., such as an API of a system or platform as described herein). In this example, the router 1106 may direct the output to an API request handler 1108. In another example, the router 1106 may determine that the generative output may be suitably directed to a graphical user interface/frontend.

Another example architecture is shown in FIG. 11B, illustrating a system providing prompt management, and in particular multiplatform prompt management as a service. The system 1100b is instantiated over cloud resources, which may be provisioned from a pool of resources in one or more locations (e.g., datacenters). In the illustrated embodiment, the provisioned resources are identified as the multi-platform host services 1112.

The multi-platform host services 1112 can receive input from one or more users in a variety of ways. For example, some users may provide input via an editor region 1114 of a frontend, such as described above. Other users may provide input by engaging with other user interface elements 1116 unrelated to common or shared features across multiple platforms. Specifically, the second user may provide input to the multi-platform host services 1112 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 1112 can include multiple software instances or microservices each configured to receive user inputs and/or proposed prompts and configured to provide, as output, an engineered prompt. In many cases, these instances—shown in the figure as the platform-specific prompt engineering services 1118, 1120—can be configured to wrap proposed prompts within engineered prompts retrieved from a database such as described above.

In many cases, the platform-specific prompt engineering services 1118, 1120 can each be configured to authenticate requests received from various sources. In other cases, requests from editor regions or other user interface elements of particular frontends can be first received by one or more authenticator instances, such as the authentication instances 1122, 1124. In other cases, a single centralized authentication service can provide authentication as a service to each request before it is forwarded to the platform-specific prompt engineering services 1118, 1120.

Once a prompt has been engineered/supplemented by one of the platform-specific prompt engineering services 1118, 1120, it may be passed to a request queue/API request handler 1126 configured to generate an API request directed to a generative output engine 1130 including appropriate API tokens and the engineered prompt as a portion of the body of the API request. In some cases, a service proxy 1130 can interpose the platform-specific prompt engineering services 1118, 1120 and the request queue/API request handler 1126, so as to further modify or validate prompts prior to wrapping those prompts in an API call to the generative output engine 1128 by the request queue/API request handler 1126 although this is not required of all embodiments.

These foregoing embodiments depicted in FIGS. 10A-10B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output once a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

FIG. 12 shows a sample electrical block diagram of an electronic device 1200 that may perform the operations described herein. The electronic device 1200 may in some cases take the form of any of the electronic devices described with reference to FIGS. 1-11 including client devices, and/or servers or other computing devices associated with the system 100. The electronic device 1200 can include one or more of a processing unit 1202, a memory 1204 or storage device, input devices 1206, a display 1208, output devices 1210, and a power source 1212. In some cases, various implementations of the electronic device 1200 may lack some or all of these components and/or include additional or alternative components.

The processing unit 1202 can control some or all of the operations of the electronic device 1200. The processing unit 1202 can communicate, either directly or indirectly, with some or all of the components of the electronic device 1200. For example, a system bus or other communication mechanism 1214 can provide communication between the processing unit 1202, the power source 1212, the memory 1204, the input device(s) 1206, and the output device(s) 1210.

The processing unit 1202 can be implemented as any electronic device capable of processing, receiving, or transmitting data or instructions. For example, the processing unit 1202 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1200 can be controlled by multiple processing units. For example, select components of the electronic device 1200 (e.g., an input device 1206) may be controlled by a first processing unit and other components of the electronic device 1200 (e.g., the display 1208) may be controlled by a second processing unit, where the first and second processing units may or may not be in communication with each other.

The power source 1212 can be implemented with any device capable of providing energy to the electronic device 1200. For example, the power source 1212 may be one or more batteries or rechargeable batteries. Additionally, or alternatively, the power source 1212 can be a power connector or power cord that connects the electronic device 1200 to another power source, such as a wall outlet.

The memory 1204 can store electronic data that can be used by the electronic device 1200. For example, the memory 1204 can store electronic data or content such as, for example, audio and video files, documents and applications, device settings and user preferences, timing signals, control signals, and data structures or databases. The memory 1204 can be configured as any type of memory. By way of example only, the memory 1204 can be implemented as random access memory, read-only memory, flash memory, removable memory, other types of storage elements, or combinations of such devices.

In various embodiments, the display 1208 provides a graphical output, for example, associated with an operating system, user interface, and/or applications of the electronic device 1200 (e.g., a chat user interface, an issue-tracking user interface, an issue-discovery user interface, etc.). In one embodiment, the display 1208 includes one or more sensors and is configured as a touch-sensitive (e.g., single-touch, multi-touch) and/or force-sensitive display to receive inputs from a user. For example, the display 1208 may be integrated with a touch sensor (e.g., a capacitive touch sensor) and/or a force sensor to provide a touch- and/or force-sensitive display. The display 1208 is operably coupled to the processing unit 1202 of the electronic device 1200.

The display 1208 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1208 is positioned beneath and viewable through a cover that forms at least a portion of an enclosure of the electronic device 1200.

In various embodiments, the input devices 1206 may include any suitable components for detecting inputs. Examples of input devices 1206 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1206 may be configured to detect one or more particular types of input and provide a signal (e.g., an input signal) corresponding to the detected input. The signal may be provided, for example, to the processing unit 1202.

As discussed above, in some cases, the input device(s) 1206 include a touch sensor (e.g., a capacitive touch sensor) integrated with the display 1208 to provide a touch-sensitive display. Similarly, in some cases, the input device(s) 1206 include a force sensor (e.g., a capacitive force sensor) integrated with the display 1208 to provide a force-sensitive display.

The output devices 1210 may include any suitable components for providing outputs. Examples of output devices 1210 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 1210 may be configured to receive one or more signals (e.g., an output signal provided by the processing unit 1202) and provide an output corresponding to the signal.

In some cases, input devices 1206 and output devices 1210 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1202 may be operably coupled to the input devices 1206 and the output devices 1210. The processing unit 1202 may be adapted to exchange signals with the input devices 1206 and the output devices 1210. For example, the processing unit 1202 may receive an input signal from an input device 1206 that corresponds to an input detected by the input device 1206. The processing unit 1202 may interpret the received input signal to determine whether to provide and/or change one or more outputs in response to the input signal. The processing unit 1202 may then send an output signal to one or more of the output devices 1210, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for operating a graphical user interface of an issue intake portal, the method comprising:
causing display of an intake portal graphical user interface of the issue intake portal on a client device, the intake portal graphical user interface including:
a text input region configured to receive user input;
a first graphical object selectable to cause redirection of the graphical user interface to an issue creation interface of an issue tracking platform; and
a second graphical object selectable to cause redirection of the graphical user interface to a chat interface of a chat platform;
in response to receiving at least a partial natural language input provided to the text input region, performing an analysis of the natural language input using an intent analysis model to obtain a set of confidence scores including:
a first confidence score corresponding to a first intent for an asynchronous interface; and
a second confidence score corresponding to a second intent for a synchronous interface;
in response to the first confidence score exceeding the second confidence score by a first threshold value:
suppressing display of the second graphical object; and
in response to a user selection of the first graphical object, causing display of the issue creation graphical user interface of the issue tracking platform; and
in response to the second confidence score exceeding the first confidence score by a second threshold value:
suppressing display of the first graphical object; and
in response to a user selection of the second graphical object, causing display of the chat interface of the chat platform.

2. The computer-implemented method of claim 1, wherein:
in response to the first confidence score and the second confidence score being below a third threshold value:
generating a prompt comprising:
at least a portion of the natural language input;
content extracted from one or more issues of the issue tracking platform; and
predetermined prompt text;
providing the prompt to a generative output engine to receive a generative response;
causing display of a suggested input text string corresponding to the generative response in the text input region; and
in response to a second user input modifying the suggested input text string, performing a second analysis of the modified suggested input text string using the intent analysis model to obtain a second set of confidence scores.

3. The computer-implemented method of claim 2, wherein:
the second set of confidence scores includes a third and fourth confidence score;
in response to the third confidence score exceeding the fourth confidence score by the first threshold value, suppressing display of the second graphical object; and
in response to the fourth confidence score exceeding the third confidence score by the second threshold value, suppressing display of the first graphical object.

4. The computer-implemented method of claim 1, wherein in response to the first confidence score and the second confidence score being above a third threshold value and within a fourth threshold value of each other, maintaining display of the first graphical object and the second graphical object.

5. The computer-implemented method of claim 1, wherein:
the set of confidence scores includes a third confidence score;
in response to the third confidence score exceeding a third threshold value, causing a search of the issue tracking platform using text extracted from the natural language user input to obtain a set of candidate electronic documents; and
causing display of a set of graphical objects, each graphical object selectable to cause the graphical user interface to be redirected to a respective one of the set of candidate electronic documents.

6. The computer-implemented method of claim 1, wherein:
in response to the first confidence score exceeding the second confidence score by the first threshold value:
suppressing display of the second graphical object; and
causing display of a link that is selectable to cause display of the chat interface.

7. The computer-implemented method of claim 1, wherein:
subsequent to receiving the natural language input to the text input region, receiving a modified natural language input;
performing an analysis of the modified natural language input using the intent analysis model to obtain a second set of confidence scores including:
a third confidence score corresponding to the first intent for an asynchronous interface; and
a fourth confidence score corresponding to the second intent for a synchronous interface;
in response to the third confidence score exceeding the fourth confidence score by the first threshold value, suppressing display of the second graphical object; and
in response to the fourth confidence score exceeding the third confidence score by the second threshold value, suppressing display of the first graphical object.

8. A computer-implemented method for operating a graphical user interface of an issue intake portal, the method comprising:
causing display of the graphical user interface of the issue intake portal on a client device, the graphical user interface including an editor region, a first selectable graphical object associated with an issue tracking platform, a second selectable graphical object associated with a communication platform;
in response to receiving a first portion of a natural language input provided to a text input region, providing the first portion of the natural language input to an intent analysis model trained using a training set of previously resolved issues processed by the issue tracking system;
receiving a set of confidence scores from the intent analysis model;
in response to the set of confidence scores satisfying a synchronous criteria, replacing the first graphical object with a first selectable text string;
in response to the set of confidence scores satisfying an asynchronous criteria, replacing the second graphical object with a second selectable text string or suppressing display of the second graphical object and the second selectable text string;
in response to a user selection of the first graphical object or the first selectable text string, causing display of an issue creation graphical user interface of the issue tracking platform; and
in response to a user selection of the second graphical object or the second selectable text string, causing display of an interface of the communication platform.

9. The computer-implemented method of claim 8, wherein:
in response to receiving the first portion of the natural language input provided to the text input region:
obtaining a user profile associated with an authenticated user of the client device;
obtaining role-specific data associated with the user role from the user profile; and
providing the role-specific data along with the first portion of the natural language input to the intent analysis model.

10. The computer-implemented method of claim 8, wherein:
the intent analysis model is trained using the training set of previously resolved issues, the training set of previously resolved issues associated with a particular tenant and the training produces a tenant-specific model;
in response to an authenticated user of the client device being associated with an account of the particular tenant, selecting the tenant-specific model for use as the intent analysis model; and
in response to the authenticated user of the client device being associated with an account of a second tenant different than the particular tenant, selecting a second model for use as the intent analysis model.

11. The computer-implemented method of claim 8, wherein:
in response to the set of confidence scores satisfying a user-directed criteria, causing a search of a knowledge base of content items using one or more tokens extracted from the natural language input to obtain a set of content item results;
ranking the set of content item results based on a prior usage criteria; and
causing display of a set of selectable objects in the graphical user interface, each selectable object of the set of selectable objects selectable to cause display of a respective one of a subset of top-ranking content items selected in accordance with the ranking.

12. The computer-implemented method of claim 8, wherein ranking the set of content item results based on the prior usage criteria includes identifying articles associated with one or more previously resolved issues managed by the issue tracking platform.

13. The computer-implemented method of claim 8, wherein:
subsequent to receiving the first portion of the natural language input, receiving a second portion of the natural language input;
performing an analysis of the first and second portions of the natural language input using the intent analysis model to obtain a second set of confidence scores; and
in response to the set of second confidence scores satisfying a synchronous criteria, replacing the first graphical object with a first selectable text string.

14. The computer-implemented method of claim 8, wherein:
subsequent to receiving the first portion of the natural language input, receiving a second portion of the natural language input;
performing an analysis of the first and second portions of the natural language input using the intent analysis model to obtain a second set of confidence scores; and
in response to the set of second confidence scores satisfying a synchronous criteria, suppressing display of the first graphical object.

15. The computer-implemented method of claim 8, wherein
in response to the set of confidence scores satisfying an ambiguity criteria:
generating a prompt comprising:
at least a portion of the first portion of the natural language input;
content extracted from one or more issues of the issue tracking platform; and
predetermined prompt text;
providing the prompt to a generative output engine to receive a generative response;
causing display of a suggested input text string corresponding to the generative response in the text input region; and
in response to a second user input adopting or modifying the suggested input text string, performing a second analysis of the modified or adopted suggested input text string using the intent analysis model to obtain a second set of confidence scores.

16. A computer-implemented method for operating a graphical user interface of an issue intake portal, the method comprising:
causing display of an intake portal graphical user interface of the issue intake portal on a client device, the intake portal graphical user interface comprising a first selectable graphical object associated with an issue tracking platform and a second selectable graphical object associated with a chat platform;
in response to receiving a first portion of a natural language input provided to a text input region, providing the first portion of the natural language input to an intent analysis model and obtaining a first set of confidence scores including:
a first confidence score corresponding to a first intent; and
a second confidence score corresponding to a second intent;
in response to a first comparison between the first confidence score and the second confidence score satisfying an asynchronous criteria, ceasing display of the second graphical object;
in response to the first comparison between the first confidence score and the second confidence score satisfying a synchronous criteria, ceasing display of the first graphical object;
in response to receiving a second portion of the natural language input provided to the text input region, providing the first and second portions of the natural language input to the intent analysis model and obtaining a second set of confidence scores including an updated first confidence score and an updated second confidence score;
in response to a second comparison between the updated first confidence score and the updated second confidence score satisfying the asynchronous criteria, causing display of the first graphical object; and
in response to the second comparison between the updated first confidence score and the updated second confidence score satisfying the synchronous criteria, causing display of the second graphical object.

17. The computer-implemented method of claim 16, wherein:
the first portion of the natural language input includes a first portion of a sentence; and
in response to receiving the second portion of the natural language input including at least a second portion of the sentence, performing an analysis of the first and second portions of the natural language input using the intent analysis model to obtain the second set of confidence scores.

18. The computer-implemented method of claim 16, wherein:
in response to receiving the first portion of the natural language input, causing a search of a store of content items using a set of keywords extracted from the first portion of the natural language user input to obtain a set of content items; and
causing display of a set of selectable objects in the graphical user interface, each selectable object of the set of selectable objects selectable to cause display of a respective one content item of the set of content items.

19. The computer-implemented method of claim 18, wherein
in response to receiving the first portion of the natural language input, causing a search of a store of content items using a set of keywords extracted from the first portion of the natural language user input to obtain a set of content items; and
causing display of a set of selectable objects in the graphical user interface, each selectable object of the set of selectable objects selectable to cause display of a respective one content item of the set of content items.

20. The computer-implemented method of claim 16, wherein:
in response to the first comparison between the first confidence score and the second confidence score satisfying the synchronous criteria, ceasing display of the first graphical object and replacing the first graphical object with a first text link; and
the first text link selectable to cause display of an interface of the issue tracking platform.
